(19) United States
(12) Patent Application Publication
(10) Pub. No.: US 2026/0217020 A1
(43) Pub. Date: Jul. 30, 2026

(54) LIQUID EJECTION APPARATUS

(71) Applicant: SEIKO EPSON CORPORATION, Tokyo (JP)

(72) Inventors: Kohei UENO, SHIOJIRI-SHI (JP); Shintaro KOMURO, MATSUMOTO-SHI (JP); Kazuyoshi OHASHI, MATSUMOTO-SHI (JP)

(21) Appl. No.: 19/459,073

(22) Filed: Jan. 26, 2026

(30) Foreign Application Priority Data
Jan. 28, 2025 (JP) 2025-012364

(51) Int. Cl. B41J 2/045; B41J 2/145; B41J 2/17; B41J 2/175

(52) U.S. Cl. CPC B41J 2/04501; B41J 2/145; B41J 2/1707; B41J 2/17596

(57) ABSTRACT

A liquid ejection apparatus includes a liquid ejection unit, a flow path that allows a liquid to flow from a plurality of liquid containers to the liquid ejection unit, and a control unit. The flow path includes a plurality of supply flow paths that supply the liquid from the liquid containers, a common flow path that is coupled to at least one of the plurality of supply flow paths and allows the liquid to flow to the liquid ejection unit, and a switching unit that switches the supply flow path coupled to the common flow path, and the plurality of supply flow paths include a first supply flow path that supplies the liquid from a first liquid container, a second supply flow path that supplies the liquid from a second liquid container, and a third supply flow path that supplies the liquid from a third liquid container.

The present application is based on, and claims priority from JP Application Serial Number 2025-012364, filed January 28, 2025, the disclosure of which is hereby incorporated by reference herein in its entirety.

### BACKGROUND

### 1. Technical Field

The present disclosure relates to a liquid ejection apparatus that ejects a liquid onto a medium.

### 2. Related Art

An inkjet recording apparatus disclosed in JP-A-2019-188699 includes a liquid supply unit that supplies a liquid to a conveyed sheet. The liquid supplied by the liquid supply unit includes colored ink and a pre-treatment liquid that is supplied to the sheet before the colored ink is supplied.

Accordingly, the liquid supply unit includes a head portion that ejects the colored ink and a head portion that ejects the pre-treatment liquid. The pre-treatment liquid is assumed to be white ink. The head portion that ejects the pre-treatment liquid is disposed adjacent to the head portion that ejects the colored ink upstream in a sheet conveyance direction.

JP-A-2019-188699 is an example of the related art.

In the inkjet recording apparatus disclosed in JP-A-2019-188699, since the head portion that ejects the pre-treatment liquid is disposed, upstream in the sheet conveyance direction, adjacent to the head portion that ejects the colored ink, the pre-treatment liquid and the colored ink may be mixed to cause a malfunction. As the malfunction, in the case of the inkjet recording apparatus disclosed in JP-A-2019-188699, poor color development may occur. In addition, another example of the malfunction is nozzle clogging due to an increase in viscosity of the liquid, depending on properties of the pre-treatment liquid.

Such a problem occurs not only when the pre-treatment liquid is ejected but also when a post-treatment liquid is ejected, and the pre-treatment liquid will be described below as an example of a treatment liquid.

The problem of mixing between the pre-treatment liquid and the colored ink may also occur when the head portion that ejects the pre-treatment liquid is disposed, downstream in the sheet conveyance direction, adjacent to the head portion that ejects the colored ink.

The above-described problem can be solved by separately configuring an apparatus for ejecting the colored ink and an apparatus for ejecting the pre-treatment liquid, and coupling the two apparatuses. However, since the apparatus for ejecting the pre-treatment liquid has no purpose other than ejecting the pre-treatment liquid, user usability is poor.

### SUMMARY

In order to solve the above-described problem, a liquid ejection apparatus according to the present disclosure includes: a liquid ejection unit including a plurality of nozzles that eject a liquid onto a medium, the liquid being supplied from a plurality of liquid containers that contain the liquid; a flow path configured to allow the liquid to flow from the liquid containers to the liquid ejection unit; and a control unit configured to control the apparatus, in which the plurality of liquid containers include a first liquid container that contains a recording liquid as the liquid for recording on the medium, a second liquid container configured to contain a treatment liquid as the liquid for performing a treatment on the medium, and a third liquid container configured to contain a cleaning liquid as the liquid for cleaning the flow path, the flow path includes a plurality of supply flow paths that allow the liquid to be supplied from the liquid containers, a common flow path that is coupled to at least one of the plurality of supply flow paths and allows the liquid to flow to the liquid ejection unit, and a switching unit that switches the supply flow path coupled to the common flow path, and the plurality of supply flow paths include a first supply flow path that supplies the liquid from the first liquid container, a second supply flow path that supplies the liquid from the second liquid container, and a third supply flow path that supplies the liquid from the third liquid container.

### BRIEF DESCRIPTION OF THE DRAWINGS

FIG. 1 shows a medium conveyance path of a liquid ejection apparatus.

FIG. 2 shows a medium conveyance path of a liquid ejection system.

FIG. 3 is a block diagram showing a control system of the liquid ejection apparatus.

FIG. 4 schematically shows a liquid flow path.

FIG. 5 schematically shows a structure of a flow path selection unit.

FIG. 6 is a table showing a relationship between a liquid ejection mode and selection by the flow path selection unit.

FIG. 7 shows a main flow of control performed by a control unit.

FIG. 8 is a flowchart showing a flow of mode determination processing.

FIG. 9 schematically shows the liquid flow path.

FIG. 10 shows another embodiment of a liquid container.

FIG. 11 is a flowchart showing a flow of a reserved job.

FIG. 12 is a flowchart showing a flow of a modification of the mode determination processing.

FIG. 13 schematically shows a flow path when a plurality of waste liquid containers are used.

FIG. 14 schematically shows a configuration of a switching unit for switching a flow destination of a waste liquid from a common waste liquid flow path.

FIG. 15 shows a configuration in which a large-capacity waste liquid container can be mounted at a first mounting portion and a second mounting portion.

### DESCRIPTION OF EMBODIMENTS

The present disclosure will schematically be described below.

A liquid ejection apparatus according to a first aspect includes: a liquid ejection unit including a plurality of nozzles that eject a liquid onto a medium, the liquid being supplied from a plurality of liquid containers that contain the liquid; a flow path configured to allow the liquid to flow from the liquid containers to the liquid ejection unit; and a control unit configured to control the apparatus, in which the plurality of liquid containers include a first liquid container that contains a recording liquid as the liquid for recording on the medium, a second liquid container that contains a treatment liquid as the liquid for performing a treatment on the medium, and a third liquid container that contains a cleaning liquid as the liquid for cleaning the flow path, the flow path includes a plurality of supply flow paths that allow the liquid to be supplied from the liquid containers, a common flow path that is coupled to at least one of the plurality of supply flow paths and allows the liquid to flow to the liquid ejection unit, and a switching unit that switches the supply flow path coupled to the common flow path, and the plurality of supply flow paths include a first supply flow path that supplies the liquid from the first liquid container, a second supply flow path that supplies the liquid from the second liquid container, and a third supply flow path that supplies the liquid from the third liquid container.

According to this aspect, ejection of the recording liquid and ejection of the treatment liquid onto the medium can be executed by one liquid ejection apparatus. Accordingly, a dedicated liquid ejection apparatus that ejects the treatment liquid is not required, the number of usage patterns of the liquid ejection apparatus increases, and user usability is improved.

In addition, since the flow path can be cleaned, by cleaning the flow path, it is possible to prevent the liquid of different types from being mixed, and thus it is possible to obtain a favorable result.

A second aspect is an aspect dependent on the first aspect, in which, when the treatment liquid is contained in the second liquid container and the supply flow path coupled to the common flow path is switched from one of the first supply flow path and the second supply flow path to the other, the control unit couples the third supply flow path to the common flow path, cleans the common flow path with the cleaning liquid, and then switches the supply flow path coupled to the common flow path from the one of the first supply flow path and the second supply flow path to the other.

According to this aspect, when the supply flow path coupled to the common flow path is switched from one of the first supply flow path and the second supply flow path to the other, it is possible to prevent the recording liquid and the treatment liquid from being mixed, and it is possible to obtain a favorable result.

A third aspect is an aspect dependent on the first aspect, in which the control unit switches the supply flow path coupled to the common flow path after discharging the liquid in the common flow path.

According to this aspect, the control unit switches the supply flow path coupled to the common flow path after discharging the liquid in the common flow path, and thus it is possible to prevent different liquids from being mixed in the common flow path.

This aspect is not limited to the first aspect described above, but may also be dependent on the second aspect described above.

A fourth aspect is an aspect dependent on the first aspect, in which the switching unit includes a first switching valve that switches connection and disconnection between the common flow path and the first supply flow path, a second switching valve that switches connection and disconnection between the common flow path and the second supply flow path, and a third switching valve that switches connection and disconnection between the common flow path and the third supply flow path.

According to this aspect, the supply flow path coupled to the common flow path can be appropriately switched by the first switching valve, the second switching valve, and the third switching valve.

This aspect is not limited to the first aspect described above, but may also be dependent on the second or third aspect described above.

In a fifth aspect, a flow path length of the common flow path is shorter than a flow path length of each of the first supply flow path, the second supply flow path, and the third supply flow path.

When the liquid flowing through the common flow path is switched, the liquid in the common flow path is wasted. According to this aspect, since the flow path length of the common flow path is shorter than the flow path length of each of the first supply flow path, the second supply flow path, and the third supply flow path, it is possible to reduce an amount of the liquid that is wasted.

This aspect is not limited to the first aspect described above, but may also be dependent on any one of the second to fourth aspects described above.

A sixth aspect is an aspect dependent on the first aspect, in which, when the recording liquid is contained in the first liquid container and the second liquid container, the control unit couples the first supply flow path and the second supply flow path to the common flow path.

According to this aspect, when the recording liquid is contained in the first liquid container and the second liquid container, the control unit couples the first supply flow path and the second supply flow path to the common flow path, and thus it is possible to extend a usable period of the recording liquid.

This aspect is not limited to the first aspect described above, but may also be dependent on any one of the second to fifth aspects described above.

A seventh aspect is an aspect dependent on the first aspect, in which the control unit is capable of switching among a recording mode in which the first supply flow path is coupled to the common flow path and the recording can be performed on the medium with the recording liquid, a treatment mode in which the second supply flow path is coupled to the common flow path and the treatment can be performed on the medium with the treatment liquid, and a cleaning mode in which the third supply flow path is coupled to the common flow path and the flow path can be cleaned with the cleaning liquid, and the control unit is further configured to receive a reservation for cleaning the flow path by the cleaning mode and switching to the recording mode after a job in the treatment mode is completed.

According to this aspect, since the control unit can receive the reservation for cleaning the flow path by the cleaning mode and switching to the recording mode after the job in the treatment mode is completed, usability is improved. For example, when ejection of the treatment liquid and ejection of the recording liquid are performed on a large amount of media, since the ejection of the treatment liquid, the cleaning of the flow path, and the switching to the recording mode are completed by executing the reservation, the recording liquid can be quickly ejected.

This aspect is not limited to the first aspect described above, but may also be dependent on any one of the second to sixth aspects described above.

An eighth aspect is an aspect dependent on the first aspect, in which the control unit is capable of switching among a recording mode in which the first supply flow path is coupled to the common flow path and the recording can be performed on the medium with the recording liquid, a treatment mode in which the second supply flow path is coupled to the common flow path and the treatment can be performed on the medium with the treatment liquid, and a cleaning mode in which the third supply flow path is coupled to the common flow path and the flow path can be cleaned with the cleaning liquid, and the control unit further detects, by receiving a job, switching from one mode of the recording mode and the treatment mode to the other mode, and switches the switching unit.

According to this aspect, the control unit detects, by receiving the job, the switching from one mode of the recording mode and the treatment mode to the other mode, and switches the switching unit, thereby improving usability.

This aspect is not limited to the first aspect described above, but may also be dependent on any one of the second to seventh aspects described above.

A ninth aspect is an aspect dependent on the first aspect, in which the control unit is capable of switching among a recording mode in which the first supply flow path is coupled to the common flow path and the recording can be performed on the medium with the recording liquid, a treatment mode in which the second supply flow path is coupled to the common flow path and the treatment can be performed on the medium with the treatment liquid, and a cleaning mode in which the third supply flow path is coupled to the common flow path and the flow path can be cleaned with the cleaning liquid, and the control unit further detects, based on an input from an input unit, mode switching, and switches the switching unit.

According to this aspect, since the control unit detects, based on the input from the input unit, the mode switching and switches the switching unit, the mode can be switched according to an intention of a user.

A tenth aspect is an aspect dependent on any one of the first to ninth aspects, in which the recording liquid serves as a first recording liquid, the plurality of liquid containers further include a fourth liquid container that contains a second recording liquid of a color different from a color of the first recording liquid, the plurality of supply flow paths further include a fourth supply flow path that supplies the liquid from the fourth liquid container, the liquid ejection unit includes a first nozzle and a second nozzle that are nozzles for ejecting the liquid, the common flow path is a first common flow path, and a second common flow path that is coupled to at least one of the plurality of supply flow paths and allows the liquid to flow to the liquid ejection unit is further provided, the first common flow path allows the liquid to flow to the first nozzle, the second common flow path allows the liquid to flow to the second nozzle, the switching unit includes a first flow path selection unit provided for the first common flow path, and a second flow path selection unit provided for the second common flow path, the first supply flow path is couplable to the first common flow path via the first flow path selection unit, the third supply flow path is couplable to the first common flow path via the first flow path selection unit and couplable to the second common flow path via the second flow path selection unit, and the fourth supply flow path is couplable to the second common flow path via the second flow path selection unit.

According to this aspect, color recording can be performed using the first recording liquid and the second recording liquid of a color different from that of the first recording liquid. In addition, since the liquid contained in the third liquid container can be supplied to both the first nozzle and the second nozzle, a degree of freedom in a usage aspect of the third liquid container is improved.

An eleventh aspect is an aspect dependent on the tenth aspect, in which the second supply flow path is couplable to the first common flow path via the first flow path selection unit and couplable to the second common flow path via the second flow path selection unit.

According to this aspect, since the liquid contained in the second liquid container can be supplied to both the first nozzle and the second nozzle, a degree of freedom in a usage aspect of the second liquid container is improved.

A twelfth aspect is an aspect dependent on the tenth aspect, in which, when the treatment liquid is ejected from the first nozzle, the third supply flow path is coupled to the second common flow path via the second flow path selection unit.

Even when the treatment liquid is ejected from the first nozzle, since the liquid is also ejected or suctioned from the second nozzle during maintenance or the like, the liquid is wasted, and the cost of the liquid increases. However, according to this aspect, when the treatment liquid is ejected from the first nozzle, since the third supply flow path is coupled to the second common flow path via the second flow path selection unit, the cost of the liquid can be reduced by containing the cleaning liquid in the third liquid container. This is because the cleaning liquid is less expensive in most cases than the recording liquid and the treatment liquid.

This aspect is not limited to the tenth aspect described above, but may also be dependent on the eleventh aspect described above.

A thirteenth aspect is an aspect dependent on any one of the first to ninth aspects, in which the plurality of liquid containers further include a fourth liquid container that contains, with the recording liquid being a first recording liquid, a second recording liquid of a color different from a color of the first recording liquid, and a fifth liquid container configured to contain the treatment liquid, the plurality of supply flow paths further include a fourth supply flow path that supplies the liquid from the fourth liquid container, and a fifth supply flow path that supplies the liquid from the fifth liquid container, the liquid ejection unit includes a first nozzle and a second nozzle that are nozzles for ejecting the liquid, the common flow path is a first common flow path, and a second common flow path that is coupled to at least one of the plurality of supply flow paths and allows the liquid to flow to the liquid ejection unit is further provided, the first common flow path allows the liquid to flow to the first nozzle, the second common flow path allows the liquid to flow to the second nozzle, the switching unit includes a first flow path selection unit provided for the first common flow path, and a second flow path selection unit provided for the second common flow path, the first supply flow path is couplable to the first common flow path via the first flow path selection unit, the second supply flow path is couplable to the first common flow path via the first flow path selection unit, the third supply flow path is couplable to the first common flow path via the first flow path selection unit and couplable to the second common flow path via the second flow path selection unit, the fourth supply flow path is couplable to the second common flow path via the second flow path selection unit, and the fifth supply flow path is couplable to the second common flow path via the second flow path selection unit.

According to this aspect, color recording can be performed using the first recording liquid and the second recording liquid of a color different from that of the first recording liquid. In addition, since the treatment liquid can be contained in the fifth liquid container in addition to the second liquid container, the treatment liquid of different types can be used. For example, a pre-treatment liquid and a post-treatment liquid can be used as the treatment liquid. It should be noted that, the treatment liquid of the same type may be contained in the second liquid container and the fifth liquid container.

A fourteenth aspect is an aspect dependent on the thirteenth aspect, in which, when the treatment liquid is ejected from the first nozzle, the third supply flow path is coupled to the second common flow path via the second flow path selection unit.

Even when the treatment liquid is ejected from the first nozzle, since the liquid is also ejected or suctioned from the second nozzle during maintenance or the like, the liquid is wasted, and the cost of the liquid increases. However, according to this aspect, when the treatment liquid is ejected from the first nozzle, since the third supply flow path is coupled to the second common flow path via the second flow path selection unit, the cost of the liquid can be reduced by containing the cleaning liquid in the third liquid container. This is because the cleaning liquid is less expensive in most cases than the recording liquid and the treatment liquid.

A fifteenth aspect is an aspect dependent on any one of the first to ninth aspects, in which a liquid holder that holds the liquid is attachable to and detachable from the liquid container.

According to this aspect, in the configuration in which the liquid holder that holds the liquid is attachable to and detachable from the liquid container, an operational effect of any one of the first to ninth aspects described above can be obtained.

This aspect is not limited to any one of the first to ninth aspects described above, but may also be dependent on any one of the tenth to fourteenth aspects described above.

A sixteenth aspect is an aspect dependent on any one of the first to ninth aspects, in which the liquid container is refillable with the liquid from a refill container containing the liquid.

According to this aspect, in the configuration in which the liquid container is refillable with the liquid from the refill container containing the liquid, the operational effect of any one of the first to ninth aspects described above can be obtained.

This aspect is not limited to any one of the first to ninth aspects described above, but may also be dependent on any one of the tenth to fourteenth aspects described above.

A seventeenth aspect is an aspect dependent on the sixteenth aspect, in which the refill container is provided with an information storage unit that stores information on the liquid, and the liquid container includes a contact couplable to a terminal for accessing the information storage unit, and a detection unit that detects an amount of the liquid contained in the liquid container.

According to this aspect, the information on the liquid contained in the refill container can be acquired by the information storage unit, and the amount of the liquid contained in the liquid container can be detected by the detection unit.

An eighteenth aspect is a control method for a liquid ejection apparatus, in which the liquid ejection apparatus includes a liquid ejection unit including a plurality of nozzles that eject a liquid onto a medium, the liquid being supplied from a plurality of liquid containers that contain the liquid, and a flow path that allows the liquid to flow from the liquid containers to the liquid ejection unit, the plurality of liquid containers include a first liquid container that contains a recording liquid as the liquid for recording on the medium, a second liquid container that contains a treatment liquid as the liquid for performing a treatment on the medium, and a third liquid container that contains a cleaning liquid as the liquid for cleaning the flow path, and the control method includes a step of setting each mode of a recording mode in which the recording liquid is ejected from the liquid ejection unit onto the medium to enable the recording on the medium, a treatment mode in which the treatment liquid is ejected from the liquid ejection unit onto the medium to enable the treatment on the medium, and a cleaning mode in which the flow path can be cleaned with the cleaning liquid.

According to this aspect, ejection of the recording liquid and ejection of the treatment liquid onto the medium can be executed by one liquid ejection apparatus. Accordingly, a dedicated liquid ejection apparatus that ejects the treatment liquid is not required, the number of usage patterns of the liquid ejection apparatus increases, and user usability is improved.

In addition, since the flow path can be cleaned, by cleaning the flow path, it is possible to prevent the liquid of different types from being mixed, and thus it is possible to obtain a favorable result.

A nineteenth aspect is an aspect dependent on the eighteenth aspect, in which the flow path is cleaned by switching to the cleaning mode before switching from one of the recording mode and the treatment mode to the other.

According to this aspect, it is possible to prevent the recording liquid and the treatment liquid from being mixed, and a favorable result is obtained.

A twentieth aspect is an aspect dependent on the nineteenth aspect, in which, when a job is received and a mode of the job does not match an apparatus mode, the flow path is cleaned by switching to the cleaning mode.

According to this aspect, since the flow path is cleaned by switching to the cleaning mode when the job is received and the mode of the job does not match the apparatus mode, it is possible to prevent the recording liquid and the treatment liquid from being mixed, and a favorable result is obtained.

A twenty-first aspect is an aspect dependent on the nineteenth or twentieth aspect, in which, when a mode corresponding to an input from an input unit does not match an apparatus mode, the flow path is cleaned by switching to the cleaning mode.

According to this aspect, since the flow path is cleaned by switching to the cleaning mode when the mode corresponding to the input from the input unit does not match the apparatus mode, it is possible to prevent the recording liquid and the treatment liquid from being mixed, and a favorable result is obtained.

A twenty-second aspect is an aspect dependent on any one of the eighteenth to twenty-first aspects, and includes: closing flow paths of the liquid to the liquid ejection unit from the first liquid container, the second liquid container, and the third liquid container; and opening a flow path to the liquid ejection unit from a liquid container suitable for a mode after switching among the first liquid container, the second liquid container, and the third liquid container.

According to this aspect, it is possible to prevent the recording liquid and the treatment liquid from being mixed in the flow path, and a favorable result is obtained.

A twenty-third aspect is an aspect dependent on any one of the eighteenth to twenty-first aspects, and includes: closing flow paths to the liquid ejection unit from the first liquid container, the second liquid container, and the third liquid container; and discharging the liquid from the liquid ejection unit and then opening a flow path to the liquid ejection unit from a liquid container suitable for a mode after switching among the first liquid container, the second liquid container, and the third liquid container.

According to this aspect, it is possible to prevent the recording liquid and the treatment liquid from being mixed in the flow path, and a favorable result is obtained.

A twenty-fourth aspect is an aspect dependent on any one of the eighteenth to twenty-first aspects, and includes: receiving a reservation for switching from the treatment mode to the recording mode; executing a job in the treatment mode when the reservation is received; switching to the cleaning mode and executing the cleaning mode after the job in the treatment mode is completed; and switching to the recording mode after the execution of the cleaning mode is completed.

According to this aspect, since the reservation can be received, usability is improved. For example, when ejection of the treatment liquid and ejection of the recording liquid are performed on a large amount of media, since the ejection of the treatment liquid, the cleaning of the flow path, and the switching to the recording mode are completed by executing the reservation, the recording liquid can be quickly ejected.

Hereinafter, the present disclosure will be specifically described.

An X-Y-Z coordinate system shown in the figures is an orthogonal coordinate system in which a direction pointed by an arrow is a +direction and a direction opposite to the + direction is a -direction. A Y-axis direction is a direction intersecting a medium conveyance direction, that is, a medium width direction, and is an apparatus depth direction. In the embodiment, among side surfaces forming a periphery of an apparatus main body 2 of a liquid ejection apparatus 1, a side surface in a +Y direction is a back surface, and a side surface in a -Y direction is a front surface.

An X-axis direction is an apparatus width direction, a +X direction is a left side and a -X direction is a right side when viewed from an operator of the liquid ejection apparatus 1. In addition, the -X direction is a direction in which a medium is fed out from each media cassette to be described later. In addition, the +X direction is the medium conveyance direction at a position facing a liquid ejection unit 12.

A Z-axis direction is a vertical direction, that is, an apparatus height direction, a +Z direction is an upward direction and a -Z direction is a downward direction.

Hereinafter, a direction in which the medium is fed may be referred to as "downstream," and an opposite direction thereof may be referred to as "upstream". In each figure, a medium conveyance path is represented by broken lines. In the liquid ejection apparatus 1, the medium is conveyed through the medium conveyance path represented by the broken line.

### Configuration of Liquid Ejection Apparatus

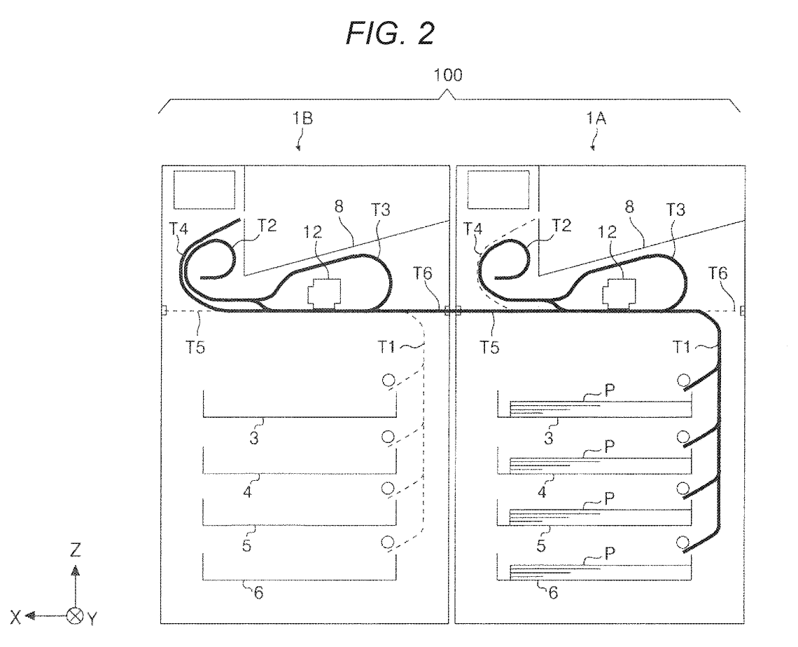

In the embodiment, the liquid ejection apparatus 1 is an inkjet printer that performs recording by ejecting ink, which is an example of a liquid, onto a medium typically represented by recording paper. A liquid ejection system 100 to be described later with reference to FIG. 2 is a system including a plurality of liquid ejection apparatuses 1.

In this specification, the terms "recording" and "printing" may be used, and both have the same meaning in that an image is formed on the medium by ejecting the liquid onto the medium. Accordingly, "recording" may be replaced with "printing" or "image formation", and "printing" may be replaced with "recording" or "image formation".

The liquid ejection apparatus 1 includes a plurality of media cassettes, specifically, a first media cassette 3, a second media cassette 4, a third media cassette 5, and a fourth media cassette 6 along the vertical direction at a lower portion of the apparatus main body 2 including the liquid ejection unit 12 to be described later. Hereinafter, these media cassettes are simply referred to as media cassettes when no distinction is made therebetween.

Each of the media cassettes is provided with a pick roller that feeds the contained medium out toward the -X direction. Reference signs 21, 22, 23, and 24 denote pick rollers provided to the media cassettes. A configuration for bringing the contained medium into contact with the pick roller may be a configuration in which the pick roller moves forward and backward with respect to the medium, or may be a configuration in which the medium is pushed up by a lift plate provided at each media cassette.

Each of the media cassettes is provided with a feed roller pair that further feeds downstream the medium fed out by the pick roller. Reference signs 25, 26, 27, and 28 denote the feed roller pairs provided at the media cassettes.

Hereinafter, unless particularly described otherwise, it is assumed that a "roller pair" includes a drive roller driven by a power source such as a motor and a driven roller driven to rotate in contact with the drive roller.

The medium fed out from the first media cassette 3 receives a feeding force from conveyance roller pairs 29 and 33, and is fed to a conveyance roller pair 34. The medium fed out from the second media cassette 4 receives a feeding force from conveyance roller pairs 30, 29, and 33, and is fed to the conveyance roller pair 34. The medium fed out from the third media cassette 5 receives a feeding force from conveyance roller pairs 31, 30, 29, and 33, and is fed to the conveyance roller pair 34. The medium fed out from the fourth media cassette 6 receives a feeding force from conveyance roller pairs 32, 31, 30, 29, and 33, and is fed to the conveyance roller pair 34. Reference sign T1 denotes a conveyance path of the medium that is fed out from each of the media cassettes and reaches the conveyance roller pair 34.

The medium that receives the feeding force from the conveyance roller pair 34 is fed between the liquid ejection unit 12 and a conveyance belt 66, that is, to a liquid ejection position facing the liquid ejection unit 12. The conveyance roller pair 34 constitutes a conveyance unit that conveys the medium between the liquid ejection unit 12 and the conveyance belt 66.

The liquid ejection unit 12 ejects the liquid onto a surface of the medium. In the embodiment, the liquid ejection unit 12 is a line head where a plurality of nozzles 13 that eject the liquid are disposed over an entire region in the medium width direction. However, the liquid ejection unit 12 may be an ink ejection head that is mounted at a carriage and ejects the liquid while moving in the medium width direction. In this case, a cartridge mounting portion 200 to be described later may be mounted at the carriage or may be provided outside the carriage.

The liquid ejection unit 12 according to the embodiment adopts a piezo element that is a piezoelectric element whose volume changes when a voltage is applied. By controlling a drive waveform of the piezo element, it is possible to control movement of a meniscus of each nozzle 13 to control a size and an ejection speed of droplets to be ejected.

In the embodiment, the plurality of nozzles 13 include a nozzle that can eject yellow ink, a nozzle that can eject magenta ink, a nozzle that can eject cyan ink, and a plurality of nozzles that can eject black ink. The ink of each color is an example of a recording liquid for recording on the medium. As will be described in detail later, a cleaning liquid can be ejected from the nozzles that eject the ink of each color, and a treatment liquid represented by a pre-treatment liquid and a post-treatment liquid can be ejected.

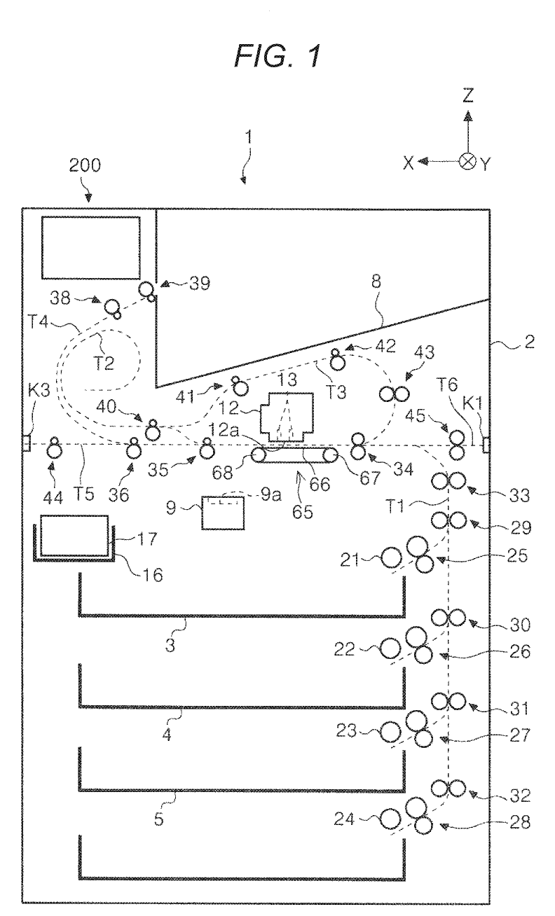

The conveyance belt 66 is an endless belt wound around a drive roller 67 and a driven roller 68, and rotates when the drive roller 67 is driven by a motor (not shown). The medium is conveyed to the position facing the liquid ejection unit 12 while being adsorbed to a belt surface of the conveyance belt 66. The drive roller 67, the driven roller 68, and the conveyance belt 66 constitute a belt unit 65. The belt unit 65 is disposed to be pivotable by a power source (not shown) with the drive roller 67 serving as a pivoting shaft, and switches, by pivoting, between a state where the medium can be conveyed as shown in FIG. 1 and a position (not shown) retracted from the liquid ejection unit 12.

The medium onto which the liquid is ejected by the liquid ejection unit 12 is fed toward any one of a conveyance roller pair 36 and a conveyance roller pair 40 by a conveyance roller pair 35 located downstream of the conveyance belt 66. Accordingly, a path switching flap (not shown) is provided in the vicinity downstream of the conveyance roller pair 35.

When the surface of the medium is not reversed and no liquid is to be ejected again onto the medium, the medium is fed from the conveyance roller pair 35 toward the conveyance roller pair 36. A discharge path T4 and a discharge path T5 can be selected downstream of the conveyance roller pair 36. Accordingly, a path switching flap (not shown) is provided in the vicinity downstream of the conveyance roller pair 36.

When the discharge path T4 is selected, the medium is discharged to a discharge tray 8 through the discharge path T4. A conveyance roller pair 38 and a conveyance roller pair 39 are provided in the discharge path T4.

When the discharge path T5 is selected, the medium is discharged toward the +X direction from a discharge portion K3 of the apparatus main body 2 through the discharge path T5. A conveyance roller pair 44 is provided in the discharge path T5.

When the surface of the medium is reversed and the liquid is ejected onto the medium again, the medium is fed from the conveyance roller pair 35 toward the conveyance roller pair 40 to enter a switchback path T2. Thereafter, a rotation direction of the conveyance roller pair 40 is switched, the medium is switched back to enter a reverse path T3, and is fed to the conveyance roller pair 34 by conveyance roller pairs 41, 42, and 43.

The liquid ejection apparatus 1 includes a receiving portion K1 that receives the medium on a side surface in the -X direction. The receiving portion K1 is provided at a height position corresponding to a position between the liquid ejection unit 12 and the belt unit 65 in the apparatus height direction. In addition, in the embodiment, height positions of the receiving portion K1 and the discharge portion K3 are substantially the same.

The medium received from the receiving portion K1 is fed to the conveyance roller pair 34 by a conveyance roller pair 45. Reference sign T6 denotes a conveyance path through which the medium received from the receiving portion K1 is conveyed. The receiving portion K1 may also serve as a feeding port when feeding the medium placed at a placement portion (not shown) provided at the side surface in the -X direction.

Reference numeral 200 denotes the cartridge mounting portion where a cartridge (to be described later) containing the liquid to be ejected from the liquid ejection unit 12 is attached and detached. The liquid to be ejected from the liquid ejection unit 12 is supplied from the cartridge mounting portion 200 to the liquid ejection unit 12 via a flow path to be described later.

Reference sign 9 denotes a cap unit including a cap 9a that caps the liquid ejection unit 12. The cap 9a is an example of a collection unit that collects ink ejected from the liquid ejection unit 12 as a waste liquid. The cap unit 9 is displaceable, by a power source (not shown) controlled by a control unit 80 to be described later, between a separation position (see FIG. 1) where the cap 9a is separated from the liquid ejection unit 12 and a cap position (not shown) where the cap 9a caps a head surface 12a of the liquid ejection unit 12.

By being configured as described above, the liquid ejection apparatus 1 can be coupled as shown in FIG. 2 as an example to form a system. The liquid ejection system 100 shown in FIG. 2 includes a first liquid ejection apparatus 1A and a second liquid ejection apparatus 1B. Each of the first liquid ejection apparatus 1A and the second liquid ejection apparatus 1B is the liquid ejection apparatus 1 described with reference to FIG. 1. In FIG. 2, the number of rollers and reference signs to be shown are reduced as compared to those in FIG. 1 in order to avoid complicating the figure.

The first liquid ejection apparatus 1A and the second liquid ejection apparatus 1B are mechanically coupled with a coupling portion (not shown) and are electrically coupled with a connector (not shown). Accordingly, the first liquid ejection apparatus 1A and the second liquid ejection apparatus 1B can communicate with each other, and the first liquid ejection apparatus 1A and the second liquid ejection apparatus 1B can eject the liquid onto the medium in cooperation with each other.

In the liquid ejection system 100, the medium is fed to the second liquid ejection apparatus 1B after the liquid is ejected by the first liquid ejection apparatus 1A, and the liquid is ejected by the second liquid ejection apparatus 1B. As an example, the first liquid ejection apparatus 1A ejects the pre-treatment liquid to be described later onto the medium, and the second liquid ejection apparatus 1B ejects ink onto the medium. However, the configuration is not limited thereto, and the first liquid ejection apparatus 1A may eject the ink onto the medium, and the second liquid ejection apparatus 1B may eject the post-treatment liquid onto the medium. Alternatively, both the first liquid ejection apparatus 1A and the second liquid ejection apparatus 1B may eject the ink onto the medium. Alternatively, both the first liquid ejection apparatus 1A and the second liquid ejection apparatus 1B may eject the treatment liquid onto the medium.

In FIG. 2, a thick solid line represents a medium conveyance path when the liquid is ejected in this way. The medium indicated by reference sign P is fed out from any one of media cassettes of the first liquid ejection apparatus 1A, and after the liquid is ejected onto a first surface, the medium is reversed, and the liquid is ejected onto a second surface. Then, the medium is fed to the second liquid ejection apparatus 1B, reversed after the liquid is ejected onto the second surface, the liquid is ejected onto the first surface, and then the medium is discharged to the discharge tray 8.

However, a discharge destination of the medium is not limited thereto, and the medium may be discharged from the discharge portion K3 through the discharge path T5. In this case, the medium may be discharged to a discharge tray (not shown) attached to a side surface in the +X direction of the second liquid ejection apparatus 1B. The discharge tray (not shown) may be attachable to and detachable from the second liquid ejection apparatus 1B. In addition, the medium discharged from the discharge portion K3 may be handed over to a treatment apparatus (not shown) disposed in the +X direction of the second liquid ejection apparatus 1B, a relay conveyance apparatus (not shown) that relays the medium to the treatment apparatus, or the like. The treatment apparatus may perform, for example, stapling, punching, saddle stitching, folding, or drying.

According to such a liquid ejection system 100, the ejection of the ink and the ejection of the treatment liquid onto the medium can be executed by one liquid ejection apparatus 1. Accordingly, a dedicated liquid ejection apparatus that ejects the treatment liquid is not required, the number of usage patterns of the two liquid ejection apparatuses increases, and user usability is improved.

In addition, when the liquid ejection apparatus is an inkjet printer as in this embodiment, since it is possible to freely set a region into which the treatment liquid is to be ejected, it is possible to reduce an amount of the used treatment liquid as compared to a configuration in which the treatment liquid is uniformly ejected to the entire surface of the medium.

The liquid ejection system 100 couples two liquid ejection apparatuses, and alternatively may couple three or more liquid ejection apparatuses. For example, when three liquid ejection apparatuses are coupled, the liquid can be ejected in order of a pre-treatment, recording, and a post-treatment.

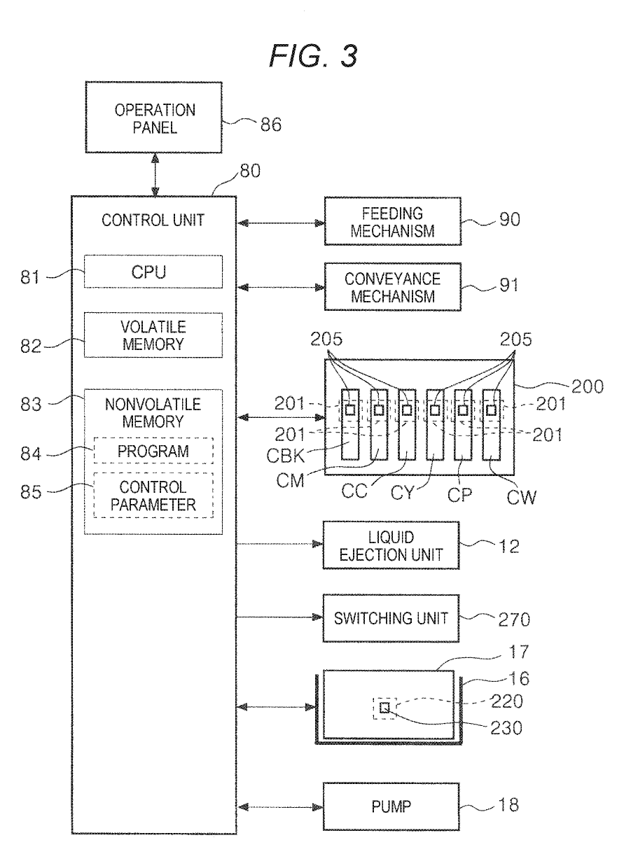

Hereinafter, the control unit 80 will be described with reference to FIG. 3.

The control unit 80 performs various types of control in the liquid ejection apparatus 1. In FIG. 3, configurations required for the following description are mainly shown, and other configurations are not shown.

The control unit 80 controls a feeding mechanism 90, a conveyance mechanism 91, the liquid ejection unit 12, a switching unit 270, a pump 18, and the cartridge mounting portion 200.

The feeding mechanism 90 includes the pick rollers 21, 22, 23, and 24, the feed roller pairs 25, 26, 27, and 28 described above, and a motor (not shown) that drives these rollers.

The conveyance mechanism 91 includes the conveyance roller pairs 29 to 45 described above, a motor (not shown) that drives these rollers, the plurality of path switching flaps that switch the feeding destination of the medium described above, and a drive source (not shown) such as a solenoid that drives the path switching flaps.

The motor (not shown) constituting the feeding mechanism 90 and the motor (not shown) constituting the conveyance mechanism 91 are, as an example, DC motors. In addition, each of the motors is provided with a rotary encoder (not shown), and the control unit 80 can detect a rotation direction, a rotation amount, and a rotation speed of each of the motors using the rotary encoder. That is, the control unit 80 can detect a drive direction, a drive amount, and a drive speed of each of the rollers.

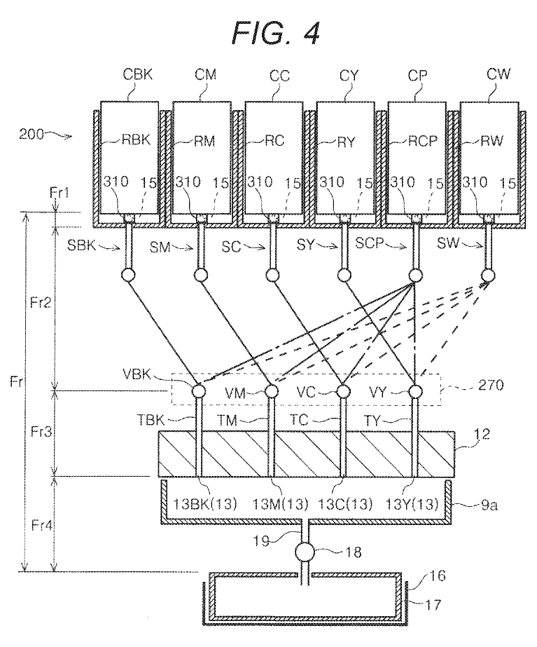

The cartridge (to be described later) containing the liquid to be ejected from the liquid ejection unit 12 can be mounted at the cartridge mounting portion 200. Types of the liquid include at least the recording liquid for recording on the medium and the treatment liquid for performing a treatment on the medium. The types of the liquid further include a cleaning liquid for cleaning a flow path Fr (see FIG. 4) through which the liquid contained in the cartridge is ejected from the liquid ejection unit 12 and flows to a waste liquid container 17 to be described later.

Ink containing a colorant is an example of the recording liquid. Examples of the treatment liquid include a pre-treatment liquid and a post-treatment liquid. The cartridge containing the ink is hereinafter referred to as an "ink cartridge" in the embodiment. The cartridge containing the treatment liquid is referred to as a "treatment liquid cartridge" in the embodiment. The treatment liquid cartridge may be a "pre-treatment liquid cartridge" containing the pre-treatment liquid or a "post-treatment liquid cartridge" containing the post-treatment liquid. The cartridge containing the cleaning liquid is referred to as a "cleaning liquid cartridge" in the embodiment. The cartridges may be simply referred to as "cartridges" when no distinction is made therebetween.

The cartridge is an example of a liquid holder that holds the liquid.

Here, the flow path Fr will be described with reference to FIG. 4. FIG. 4 schematically shows the flow path of the liquid, and the flow path Fr includes flow paths Fr1, Fr2, Fr3, and Fr4. The flow path Fr1 is a section in the cartridge mounting portion 200. The flow path Fr2 is a section between the cartridge mounting portion 200 and the switching unit 270 to be described later. The flow path Fr3 is a section between the switching unit 270 and the nozzle 13. The flow path Fr4 is a section from the cap 9a to the waste liquid container 17.

The flow path Fr can be cleaned by discharging the cleaning liquid from the nozzle 13 and operating the pump 18 in a state where the cleaning liquid cartridge is mounted at the cartridge mounting portion 200. Hereinafter, the simple phrase "cleaning of the flow path" or "cleaning processing" means cleaning of the flow path Fr.

The cartridge mounting portion 200 according to the embodiment includes a plurality of containers for containing the cartridges. Specifically, the cartridge mounting portion 200 includes a black container RBK, a magenta container RM, a cyan container RC, a yellow container RY, a treatment liquid container RCP, and a cleaning liquid container RW.

That is, a plurality of cartridges are attachable to and detachable from the cartridge mounting portion 200 according to the embodiment.

A liquid supply needle 15 is provided at a bottom portion of each of the containers. Each cartridge is provided with a supply unit 310, and when each cartridge is mounted at each container, the liquid supply needle 15 enters the supply unit 310, and it becomes possible to supply the liquid from the cartridge.

The flow path Fr includes a plurality of supply flow paths through which the liquid flows from each container to the liquid ejection unit 12, and a common flow path which is coupled to at least one of the plurality of supply flow paths and through which the liquid flows to the liquid ejection unit 12.

In the embodiment, the flow path Fr2 includes a plurality of supply flow paths, and the flow path Fr3 includes a plurality of common flow paths. Each flow path is formed of a tube as an example. In FIG. 4, in order to avoid complication of illustration, a part of tubes are drawn in a simplified manner using solid lines, one-dot chain lines, and broken lines.

The flow path Fr2 include the plurality of supply flow paths, that is, a black supply flow path SBK, a magenta supply flow path SM, a cyan supply flow path SC, a yellow supply flow path SY, a treatment liquid supply flow path SCP, and a cleaning liquid supply flow path SW. Each supply flow path is a flow path from each container to the switching unit 270.

The black supply flow path SBK is coupled to a black flow path selection unit VBK to be described later. The magenta supply flow path SM is coupled to a magenta flow path selection unit VM to be described later. The cyan supply flow path SC is coupled to a cyan flow path selection unit VC to be described later. The yellow supply flow path SY is coupled to a yellow flow path selection unit VY to be described later.

Meanwhile, the treatment liquid supply flow path SCP and the cleaning liquid supply flow path SW are coupled to all the flow path selection units. That is, the treatment liquid supply flow path SCP branches into four flow paths, and a section from a branch portion to each flow path selection unit is indicated by a one-dot chain line. In addition, the cleaning liquid supply flow path SW branches into four flow paths, and a section from a branch portion to each flow path selection unit is indicated by broken lines.

The nozzles 13 provided in the liquid ejection unit 12 include a black nozzle 13BK corresponding to black ink, a magenta nozzle 13M corresponding to magenta ink, a cyan nozzle 13C corresponding to cyan ink, and a yellow nozzle 13Y corresponding to yellow ink.

The flow path Fr3, that is, the plurality of common flow paths include a black common flow path TBK, a magenta common flow path TM, a cyan common flow path TC, and a yellow common flow path TY.

A flow path selection unit is provided for each common flow path. The black flow path selection unit VBK is provided for the black common flow path TBK. The magenta flow path selection unit VM is provided for the magenta common flow path TM. The cyan flow path selection unit VC is provided for the cyan common flow path TC. The yellow flow path selection unit VY is provided for the yellow common flow path TY. Each flow path selection unit constitutes the switching unit 270.

A supply flow path of a corresponding color is coupled to each flow path selection unit, and the treatment liquid supply flow path SCP and the cleaning liquid supply flow path SW are further coupled thereto. That is, in the embodiment, three supply flow paths are coupled to one flow path selection unit.

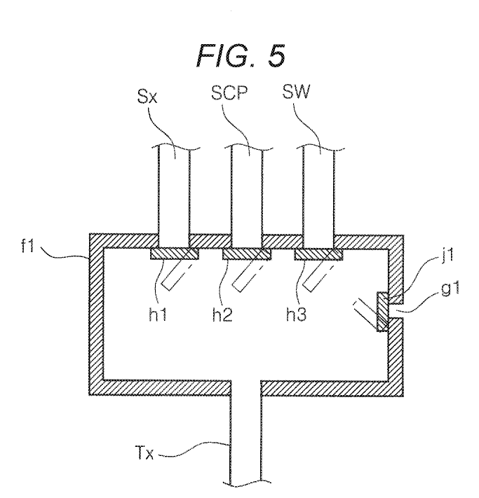

The flow path selection units have the same structure, known valves can be adopted, and as an example, as shown in FIG. 5, valves h1, h2, and h3 are provided in a case f1. The valves h1, h2, and h3 are examples of first, second, and third switching valves, respectively. A valve j1 is a valve that opens and closes an atmospheric communication hole g1. These valves can be configured with, for example, solenoid valves. For each valve, a solid line indicates a closed state and a two-dot chain line indicates an open state.

Reference sign Sx denotes any one of the supply flow paths (SBK, SM, SC, and SY) described above. Reference sign Tx denotes any one of the common flow paths (TBK, TM, TC, and TY) described above.

When the valve h1 is opened and the other valves are closed, the supply flow path Sx is coupled to the common flow path Tx. When the valve h2 is opened and the other valves are closed, the treatment liquid supply flow path SCP is coupled to the common flow path Tx. When the valve h3 is opened and the other valves are closed, the cleaning liquid supply flow path SW is coupled to the common flow path Tx.

The opening and closing of each valve described above are performed by the control unit 80.

Referring back to FIG. 4, one end of the tube 19 is coupled to the cap 9a that caps the liquid ejection unit 12. The other end of the tube 19 enters the waste liquid container 17, and accordingly, the liquid ejected to the cap 9a is collected by the waste liquid container 17 as a waste liquid. Reference sign 18 denotes the pump that generates a negative pressure in the cap 9a. When the pump 18 operates in a state where the cap 9a caps the liquid ejection unit 12, the liquid is suctioned from the nozzle 13 and fed to the waste liquid container 17. Alternatively, even when the cap 9a is separated from the liquid ejection unit 12, the liquid accumulated in the cap 9a is fed to the waste liquid container 17 by operating the pump 18. The control unit 80 controls delivery of the waste liquid to the waste liquid container 17.

The waste liquid container 17 is attachable to and detachable from the mounting portion 16.

The waste liquid stored in the waste liquid container 17 is not limited to the waste liquid collected by the cap 9a, and may be, for example when a configuration is provided in which the ink is discarded to a platen (not shown) for borderless printing, the waste liquid discarded to the platen.

As described above, in the liquid ejection apparatus 1, since the flow path Fr can be cleaned, by cleaning the flow path Fr, it is possible to prevent different types of liquids from being mixed, and thus it is possible to obtain a favorable result.

In the embodiment, since it is possible to mount the cleaning liquid cartridge containing the cleaning liquid for cleaning the flow path Fr to the cartridge mounting portion 200, the flow path Fr can easily be cleaned. By cleaning the flow path Fr, it is possible to prevent the different types of liquids from being mixed, and thus it is possible to obtain a favorable result.

In FIGS. 3 and 4, a black cartridge CBK containing black ink is mounted at the black container RBK. A magenta cartridge CM containing magenta ink is mounted at the magenta container RM. A cyan cartridge CC containing cyan ink is mounted at the cyan container RC. A yellow cartridge CY containing yellow ink is mounted at the yellow container RY. The cartridges of the respective colors may be collectively referred to as an ink cartridge Cx when no distinction is made therebetween.

In addition, a treatment liquid cartridge CP containing the treatment liquid is mounted at the treatment liquid container RCP, and a cleaning liquid cartridge CW containing the cleaning liquid is mounted at the cleaning liquid container RW.

The treatment liquid cartridge CP includes a case of a pre-treatment liquid cartridge CPa and a case of a post-treatment liquid cartridge CPb, both of which are collectively referred to when being referred to as the treatment liquid cartridge CP.

As shown in FIG. 3, each cartridge is provided with a cartridge IC 205 as an example of an information storage unit that stores information such as a type and a remaining amount of the liquid. The cartridge IC 205 stores information such as the type and the remaining amount of the liquid.

Each mounting portion is provided with a contact 201 that can electrically contact the cartridge IC 205. The control unit 80 can detect the information such as the type and the remaining amount of the liquid by reading the information from the cartridge IC 205. When the liquid is consumed, the control unit 80 updates the remaining amount information in the cartridge IC 205 based on a consumption amount thereof. The control unit 80 can also detect that the cartridge has been replaced by reading the information from the cartridge IC 205 at a predetermined timing or at predetermined intervals.

The waste liquid container 17 is provided with a waste liquid container IC 230, which is an example of an information storage unit that stores information on the waste liquid container 17. The mounting portion 16 where the waste liquid container 17 is mounted is provided with a contact 220 that can electrically contact the waste liquid container IC 230.

The control unit 80 can acquire the information on the waste liquid container 17 by reading the information from the waste liquid container IC 230. The control unit 80 can also write the information on the waste liquid container 17 into the waste liquid container IC 230. By reading the information from the waste liquid container IC 230 at a predetermined timing or at predetermined intervals, the control unit 80 can also detect that the waste liquid container 17 has been replaced.

Examples of the information on the waste liquid container 17 include at least one of individual identification information of the waste liquid container 17, whether the waste liquid is contained, a type of the contained waste liquid, and an amount of the contained waste liquid.

The information on the waste liquid container 17 may be stored in a nonvolatile memory 83 of the control unit 80 in association with, for example, the individual identification information of the waste liquid container 17.

The control unit 80 in FIG. 3 includes a CPU 81 that executes a computer program, in other words, software, a volatile memory 82, and the nonvolatile memory 83. The CPU 81 performs various calculations required for executing a program 84 stored in the nonvolatile memory 83. The volatile memory 82 is used as a temporary data storage region. The nonvolatile memory 83 stores the program 84 and a control parameter 85 required for executing the program 84. The program 84 includes a program for executing various types of processing to be described later, and the control parameter 85 includes a parameter for executing the program 84. The various types of processing to be described later are implemented by the control unit 80 executing the program 84.

In addition, the control unit 80 can receive, from an operation panel 86 provided in the liquid ejection apparatus 1, various operation settings from the user. The operation panel 86 includes a touch panel, a power button, and other setting buttons, which are not shown. The operation panel 86 displays a user interface for displaying various information to the user and receiving various operations. Hereinafter, the term "user interface" may be abbreviated as "UI".

The operation panel 86 is an example of an input unit that receives various operation settings from the user.

### Treatment Liquid and Cleaning Liquid

Hereinafter, the treatment liquid and the cleaning liquid will be described.

As shown in FIG. 4, when the ink cartridge Cx, the treatment liquid cartridge CP, and the cleaning liquid cartridge CW are mounted at the cartridge mounting portion 200, the liquid ejection apparatus 1 can execute all of the following without attaching or detaching the cartridge: recording by ejecting ink onto the medium; performing a pre-treatment or a post-treatment on the medium according to the type of treatment liquid; and cleaning the flow path Fr.

As the pre-treatment liquid, a pre-treatment liquid in the related art known as a liquid that is ejected onto the medium before ink ejection to prevent ink bleeding and improve recording quality can be appropriately adopted, and as an example, a pre-treatment liquid that uses pure water as a solvent and contains a coagulant such as a polyvalent metal salt can be adopted. It should be noted that such a pre-treatment liquid is an example and is not limited thereto.

The coagulant reacts with the colorant contained in the ink, and components such as a pigment dispersion and a resin that may be contained in the ink, thereby causing the colorant to aggregate. The coagulant also reacts with a pigment dispersion and/or a resin that may be contained in an ink composition, thereby increasing a viscosity of the ink composition. Accordingly, since an ejection failure is caused when the pre-treatment liquid and the ink are mixed in the liquid flow path Fr, it is required to interpose cleaning processing when replacing the ink cartridge Cx with the treatment liquid cartridge CP or when replacing the treatment liquid cartridge CP with the ink cartridge Cx. It should be noted that even when the pre-treatment liquid does not contain the coagulant, for example, when white ink is used as the pre-treatment liquid, since a desired treatment result cannot be obtained when mixing with the ink of another color, it is required to interpose the cleaning processing when replacing the ink cartridge Cx with the treatment liquid cartridge CP or when replacing the treatment liquid cartridge CP with the ink cartridge Cx.

As the post-treatment liquid, it is possible to appropriately adopt a post-treatment liquid in the related art known as a post-treatment liquid that is ejected onto the medium where the ink has been ejected to cover a recorded surface thereof with a protective layer formed of a coating film and thus improve water resistance, light resistance, gas resistance, abrasion resistance, glossiness, color development, and the like of a recorded image. Examples of the post-treatment liquid include, but are not limited to, a post-treatment liquid containing a water-soluble resin or a water-soluble emulsion using pure water as a solvent. Since the post-treatment liquid may also be mixed with the ink to cause, as an example, an increase in a viscosity of the ink, it is still required to interpose the cleaning processing when replacing the ink cartridge Cx with the treatment liquid cartridge CP or when replacing the treatment liquid cartridge CP with the ink cartridge Cx.

The cleaning liquid may be any cleaning liquid as long as the nozzles 13 and the flow path Fr can be cleaned, and as an example, a liquid that contains pure water as a main component and contains a surfactant, a viscosity modifier, and a defoaming agent can be adopted. It should be noted that such a cleaning liquid is an example and is not limited thereto.

### Control Related to Liquid Ejection Modes

Next, among the control performed by the control unit 80, particularly control related to liquid ejection modes will be described.

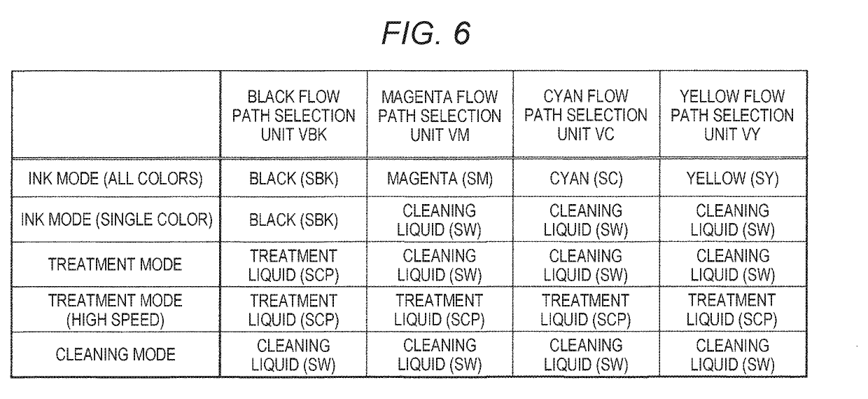

First, the liquid ejection modes of the liquid ejection apparatus 1 will be described with reference to FIG. 6. The liquid ejection apparatus 1 according to the embodiment can set a liquid ejection mode according to a selection state of each flow path selection unit as shown in FIG. 6. The liquid ejection mode differs depending on the selected supply flow path.

In the present specification, the term "liquid ejection mode" alone means a state of the liquid ejection apparatus 1. Execution of the liquid ejection mode means that processing corresponding to the liquid ejection mode is actually performed. For example, execution of an ink mode means ink ejection onto the medium, execution of a treatment mode means treatment liquid ejection onto the medium, and execution of a cleaning mode means cleaning the flow path Fr. The treatment mode includes a pre-treatment mode in which the pre-treatment liquid is ejected and a post-treatment mode in which the post-treatment liquid is ejected, and these modes are collectively referred to as the treatment mode hereinafter.

In the embodiment, the black flow path selection unit VBK can select any one of the black supply flow path SBK, the treatment liquid supply flow path SCP, and the cleaning liquid supply flow path SW and couple the selected flow path to the black common flow path TBK. The magenta flow path selection unit VM can select any one of the magenta supply flow path SM, the treatment liquid supply flow path SCP, and the cleaning liquid supply flow path SW and couple the selected flow path to the magenta common flow path TM. The cyan flow path selection unit VC can select any one of the cyan supply flow path SC, the treatment liquid supply flow path SCP, and the cleaning liquid supply flow path SW and couple the selected flow path to the cyan common flow path TC. The yellow flow path selection unit VY can select any one of the yellow supply flow path SY, the treatment liquid supply flow path SCP, and the cleaning liquid supply flow path SW and couple the selected flow path to the yellow common flow path TY.

These notations of SBK, SM, SC, SY, SCP, and SW shown in parentheses in FIG. 6 indicate the supply flow paths described above.

In the embodiment, the liquid ejection apparatus 1 can set and execute any one of an ink mode (single color), an ink mode (all colors), a treatment mode, a treatment mode (high speed), and a cleaning mode. The ink mode is an example of a recording mode in which recording can be performed on the medium with ink, which is an example of the recording liquid. It is not necessarily required that all of these modes be executed. A mode other than the above may also be provided.

The ink mode (single color) and the ink mode (all colors) are examples of a recording mode when recording is performed on the medium with ink, which is an example of the recording liquid. The treatment mode and the treatment mode (high speed) are examples of the treatment mode when a treatment is performed on the medium with the treatment liquid. The cleaning mode is a mode when the flow path Fr is cleaned with the cleaning liquid.

A control method for the liquid ejection apparatus 1 implemented by the control unit 80 includes setting and executing each mode described above.

The recording, the treatment, and the cleaning can be appropriately performed depending on each mode described above.

It is not always required to mount the cartridges at all the mounting portions of the cartridge mounting portion 200, provided that the cartridges required for the liquid ejection mode are mounted. For example, when the ink mode (all colors) is performed, the treatment liquid cartridge CP and the cleaning liquid cartridge CW may not necessarily be mounted. In addition, the ink cartridge Cx may be mountable to one or both of the treatment liquid container RCP and the cleaning liquid container RW. Accordingly, a capacity of one or two of ink cartridges Cx of four colors can be increased.

In the example in FIG. 6, in the case of the ink mode (single color), the flow path selection units other than the black flow path selection unit VBK select the cleaning liquid supply flow path SW, and alternatively, no supply flow path may be selected, that is, all of the valves h1, h2, h3, and j1 shown in FIG. 5 may be closed. Similarly, in the case of the treatment mode, the flow path selection units other than the black flow path selection unit VBK select the cleaning liquid supply flow path SW, and alternatively, no supply flow path may be selected.

In addition, the cleaning liquid cartridge CW may be mountable to both the treatment liquid container RCP and the cleaning liquid container RW, or the treatment liquid cartridge CP may be mountable. In this way, a capacity of the cleaning liquid cartridge CW or the treatment liquid cartridge CP can be increased.

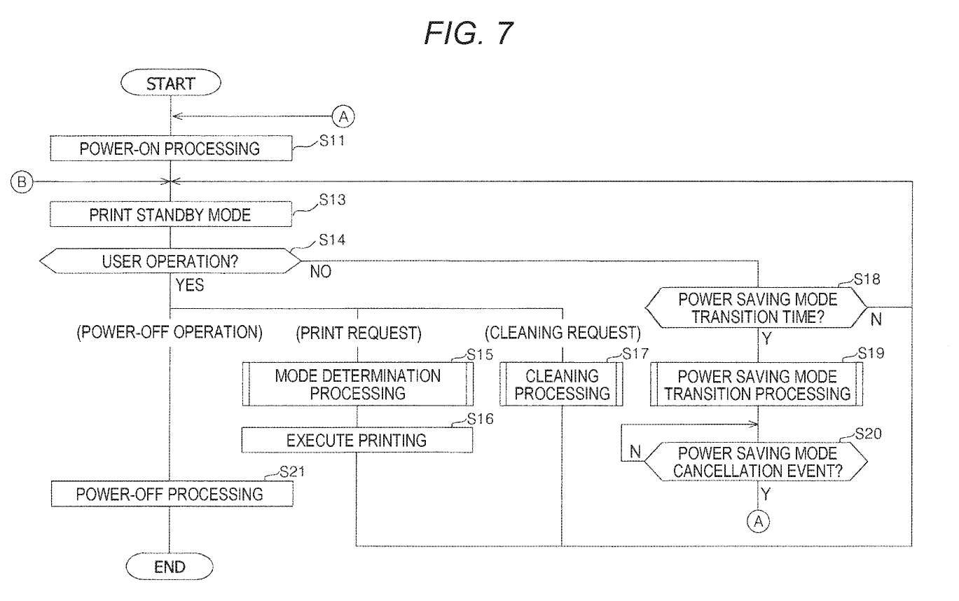

Next, processing performed by the control unit 80 will be described. FIG. 7 is a main flow of the control performed by the control unit 80.

When power of the apparatus is turned on, the control unit 80 performs power-on processing (step S11). Here, the power-on of the apparatus includes not only a case where a power button (not shown) provided on the operation panel 86 is pressed but also a case of returning from a power saving mode. The power-on processing here is initialization processing of a general printer, and includes, for example, a home detection or reset operation for a movable part.

Next, the control unit 80 enters a print standby mode (step S13). The print standby mode is a mode for waiting for a user operation.

In response to this, when there is no user operation ("No" in step S14) and a power saving mode transition time is reached (Yes in step S18), the control unit 80 performs power saving mode transition processing (step S19). Accordingly, the liquid ejection apparatus 1 enters a power saving state where power is limitedly supplied only to required portions.

In the state of the power saving mode, when a power saving mode release event occurs such as when the user touches the operation panel 86 and presses a power button (not shown) (Yes in step S20), the processing returns to step S11. When the user issues a print request in the state of the power saving mode, the control unit 80 performs the power-on processing (step S11) and then executes step S15 and subsequent steps to be described later.

Next, when there is a user operation in the state of the print standby mode ("Yes" in step S14), if a content thereof is a power-off operation, the control unit 80 performs power-off processing (step S21), and the processing ends.

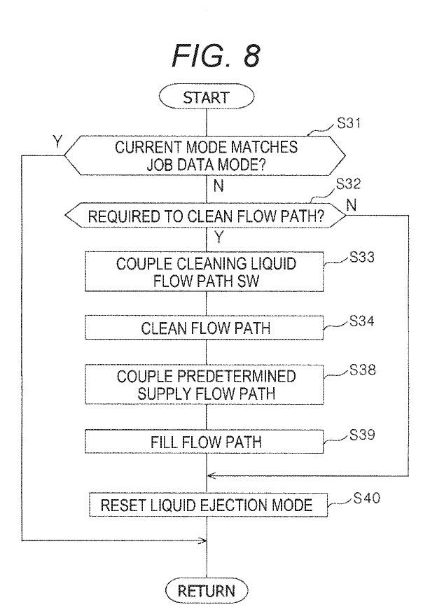

When the content of the user operation is the print request, that is, when the control unit 80 receives print job data, the processing proceeds to step S15, and mode determination processing is performed. Hereinafter, the mode determination processing will be described with reference to FIG. 8.

First, the control unit 80 determines whether the current liquid ejection mode matches the liquid ejection mode for the print job data (step S31). As a result, if the modes match (Yes in step S31), the processing returns to the main flow directly.

When the current liquid ejection mode does not match the liquid ejection mode for the print job data (No in step S31), the control unit 80 determines whether flow path cleaning is required (step S32).

Here, a case where the flow path cleaning is required (Yes in step S32) is a case where the ink and the treatment liquid are mixed in the flow path, for example, a case where the mode is switched between the ink mode (single color) or the ink mode (all colors) in FIG. 6 and the treatment mode or the treatment mode (high speed).

In this case, since it is required to clean the flow path, the control unit 80 selects the cleaning liquid supply flow path SW in each flow path selection unit, and couples the cleaning liquid supply flow path SW to each common flow path (step S33). When there is a flow path that does not require cleaning, all the valves (the valves h1, h2, h3, and j1 in FIG. 5) of the flow path selection unit may be closed. For example, when switching from the ink mode (single color) to the treatment mode in FIG. 6, it is not required to clean the flow path selection units of the magenta flow path selection unit VM, the cyan flow path selection unit VC, and the yellow flow path selection unit VY, and downstream common flow paths thereof. Accordingly, all the valves of such flow path selection units may be closed.

Next, the control unit 80 performs flow path cleaning (step S34). The flow path cleaning includes filling the flow path with the cleaning liquid, ejecting the cleaning liquid to the cap 9a, and collecting the cleaning liquid ejected to the cap 9a. The flow path is filled with the liquid (in this case, the cleaning liquid) by operating the pump 18 in a state where the liquid ejection unit 12 is capped by the cap 9a. The cleaning liquid ejected to the cap 9a is collected by operating the pump 18.

The filling of the flow path with the liquid and the ejection of the liquid to the cap 9a may directly use the same processing as maintenance for the purpose of preventing clogging of the liquid ejection unit 12, specifically, a sequence of flushing processing and nozzle suction processing. Alternatively, a sequence for ink initial filling may be directly used. Alternatively, a dedicated sequence may be used. Further, these sequences may be repeated, and accordingly, more reliable cleaning can be performed.

When the flow path cleaning ends, the control unit 80 selects a predetermined supply flow path in each flow path selection unit (step S38) and fills the flow path (step S39). For example, when the mode is switched to the ink mode (single color) in FIG. 6 after the cleaning ends, the black supply flow path SBK is selected in the black flow path selection unit VBK in step S38. The flow path filling in step S39 is performed by operating the pump 18 in the state where the liquid ejection unit 12 is capped by the cap 9a as described above.

Then, the control unit 80 resets the liquid ejection mode (step S40). The control unit 80 stores the set liquid ejection mode in the nonvolatile memory 83 (see FIG. 3).

Next, when the content of the user operation in step S14 in the main flow in FIG. 7 is the cleaning processing, the processing proceeds to step S17, and the cleaning processing is performed. Such cleaning processing is the same as the above-described cleaning processing. In the cleaning processing, all the flow path selection units and all the downstream common flow paths thereof may be cleaned, or only a flow path selection unit filled with the ink or the treatment liquid and a downstream common flow path thereof may be cleaned.

In the embodiment, the ink cartridge Cx, the treatment liquid cartridge CP, and the cleaning liquid cartridge CW have basically the same housing shape and size. However, each housing shape may be unique such that only a cartridge corresponding to each container can be mounted.

The housing shape and size may be the same, and a plurality of types of cartridges may be mountable at each container. In this case, for example, when the treatment liquid cartridge CP is mounted after the ink cartridge Cx is mounted, or when the ink cartridge Cx is mounted after the treatment liquid cartridge CP is mounted, it is preferable to mount the cleaning liquid cartridge CW and perform the cleaning processing including the supply flow path before replacing the cartridge. Accordingly, it is possible to prevent the ink and the treatment liquid from being mixed in the flow path Fr. The cleaning processing based on a user operation shown in FIG. 7 (step S17) can be used in such a case.

By reading the information from the cartridge IC 205, the control unit 80 may issue an alert to the operation panel 86 and display a UI for prompting the user to select either cartridge replacement or the cleaning processing when the treatment liquid cartridge CP is mounted at the container where the ink cartridge Cx has been mounted, when the ink cartridge Cx is mounted at the container where the treatment liquid cartridge CP has been mounted, or the like.

As an example, the UI may include a message such as "Cartridge replacement requiring cleaning has been detected. Please select whether to perform cartridge replacement after cleaning or perform cartridge replacement without cleaning".

Hereinafter, operational effects of the above-described embodiment will be described.

Names of elements used in the following description are rephrased names of elements used in the above-described embodiment, and reference signs of the corresponding elements are indicated in parentheses following the names of the elements. For example, when the second supply flow path (SCP) is described, the second supply flow path indicates the treatment liquid supply flow path SCP described above. When a plurality of elements are shown in parentheses, a reference sign of at least one element may correspond to a name of the element. For example, when the first liquid container (RBK, RM, RC, RY) is described, the first liquid container indicates at least one of the black container RBK, the magenta container RM, the cyan container RC, and the yellow container RY described above.

First, the liquid ejection apparatus 1 includes a plurality of liquid containers, that is, the first liquid container (RBK, RM, RC, RY) that contains the recording liquid as the liquid for recording on the medium, the second liquid container (RCP) that can contain the treatment liquid as the liquid for performing a treatment on the medium, and the third liquid container (RW) that can contain the cleaning liquid as the liquid for cleaning the flow path.

The flow path Fr includes a plurality of supply flow paths (SBK, SM, SC, SY, SCP, SW) that supply the liquid from the liquid container, the common flow path (TBK, TM, TC, TY) that is coupled to at least one of the plurality of supply flow paths and allows the liquid to flow to the liquid ejection unit 12, and the switching unit 270 that switches the supply flow path coupled to the common flow path.

The plurality of supply flow paths include the first supply flow path (SBK, SM, SC, SY) that supplies the liquid from the first liquid container, the second supply flow path (SCP) that supplies the liquid from the second liquid container, and the third supply flow path (SW) that supplies the liquid from the third liquid container.

With such a configuration, ejection of the recording liquid and ejection of the treatment liquid onto the medium can be executed by one liquid ejection apparatus 1. Accordingly, a dedicated liquid ejection apparatus that ejects the treatment liquid is not required, the number of usage patterns of the liquid ejection apparatus increases, and user usability is improved.

In addition, since the flow path Fr can be cleaned, by cleaning the flow path Fr, it is possible to prevent the liquid of different types from being mixed, and thus it is possible to obtain a favorable result.

When the treatment liquid is stored in the second liquid container (RCP) and the supply flow path coupled to the common flow path (TBK, TM, TC, TY) is switched from one of the first supply flow path (SBK, SM, SC, SY) and the second supply flow path (SCP) to the other, the control unit 80 couples the third supply flow path (SW) to the common flow path, cleans the common flow path with the cleaning liquid, and then switches the supply flow path coupled to the common flow path from the one of the first supply flow path and the second supply flow path to the other.

Accordingly, it is possible to prevent the recording liquid and the treatment liquid from being mixed, and a favorable result is obtained.

When switching the supply flow path coupled to the common flow path, the control unit 80 may switch after discharging the liquid in the common flow path. The discharge of the liquid in the common flow path can be implemented by suctioning by the pump 18 in a state where all the valves h1, h2, and h3 shown in FIG. 5 are closed, the valve j1 is opened, and the atmospheric communication hole g1 is opened. In this way, it is possible to prevent different liquids in the flow path selection unit and the common flow path from being mixed.

However, instead of emptying the flow path selection unit and the common flow path by discharging the liquid therein, the liquid remaining in the flow path selection unit and the common flow path may be pushed out by the liquid to be used next.

In the above-described embodiment, the switching unit 270 includes the first switching valve (h1) that switches connection and disconnection between the common flow path (TBK, TM, TC, TY) and the first supply flow path (SBK, SM, SC, SY), the second switching valve (h2) that switches connection and disconnection between the common flow path and the second supply flow path (SCP), and the third switching valve (h3) that switches connection and disconnection between the common flow path and the third supply flow path (SW). Accordingly, the supply flow path coupled to the common flow path can be appropriately switched.

In the embodiment, a flow path length of the common flow path (TBK, TM, TC, TY) is shorter than flow path lengths of the first supply flow path (SBK, SM, SC, SY), the second supply flow path (SCP), and the third supply flow path (SW). This is indicated by a difference between the flow path Fr2 and the flow path Fr3 shown in FIG. 4.

When the liquid flowing through the common flow path is switched, the liquid in the common flow path is wasted. However, since the flow path length of the common flow path is shorter than the flow path length of each of the first supply flow path, the second supply flow path, and the third supply flow path, it is possible to reduce an amount of the liquid that is wasted.

When the recording liquid is contained in the first liquid container (RBK, RM, RC, RY) and the second liquid container (RCP), the control unit 80 may couple the first supply flow path (SBK, SM, SC, SY) and the second supply flow path (SCP) to the common flow path (TBK, TM, TC, TY). Accordingly, it is possible to extend a usable period of the recording liquid.

For example, when the black cartridge CBK is mounted at the black container RBK and the black cartridge CBK is also mounted at the treatment liquid container RCP, if the black supply flow path SBK and the treatment liquid supply flow path SCP are coupled to the black common flow path TBK, it is possible to extend a usable period of the black ink. The same applies to ink of other colors.

The control unit 80 can switch to each of the ink mode, the treatment mode, and the cleaning mode. The ink mode is a mode in which the first supply flow path (SBK, SM, SC, SY) is coupled to the common flow path (TBK, TM, TC, TY), and recording on the medium is enabled with ink. The treatment mode is a mode in which the second supply flow path (SCP) is coupled to the common flow path and a treatment on the medium is enabled with the treatment liquid. The cleaning mode is a mode in which the third supply flow path (SW) is coupled to the common flow path and the flow path can be cleaned with the cleaning liquid.

Then, as described with reference to FIG. 8, the control unit 80 detects, by receiving the job, switching from one mode of the ink mode and the treatment mode to the other mode, and switches the switching unit 270, thereby improving usability.

The control unit 80 may detect the mode switching based on an input from the operation panel 86 and switch the switching unit 270. The operation panel 86 is an example of the input unit, the input unit is not limited to being provided in the liquid ejection apparatus 1, and may be provided in an external device that can communicate with the liquid ejection apparatus 1.

The liquid ejection apparatus 1 according to the embodiment further has the following features.

In the embodiment, the colors of the ink are four colors, that is, black, magenta, cyan, and yellow. Among these, any color is referred to as a first recording liquid, and another color is referred to as a second recording liquid. For example, hereinafter, black ink is described as the first recording liquid (BK), and magenta ink is described as the second recording liquid (M).

Here, the container that contains the first recording liquid (BK) is referred to as the first liquid container (RBK), and the container that stores the second recording liquid (M) is referred to as the fourth liquid container (RM). The black supply flow path SBK is referred to as the first supply flow path (SBK), and the magenta supply flow path SM that supplies the ink from the fourth liquid container (RM) is referred to as the fourth supply flow path (SM).

In addition, a nozzle that ejects the black ink is referred to as the first nozzle (13BK), and a nozzle that ejects the magenta ink is referred to as the second nozzle (13M).

The black common flow path TBK is referred to as the first common flow path (TBK), and the magenta common flow path TM is referred to as the second common flow path (TM).

The black flow path selection unit VBK provided for the first common flow path (TBK) is referred to as the first flow path selection unit (VBK), and the magenta flow path selection unit VM provided for the second common flow path (TM) is referred to as the second flow path selection unit (VM).

In the above configuration, the first supply flow path (SBK) can be coupled to the first common flow path (TBK) via the first flow path selection unit (VBK).

The third supply flow path (SW) can be coupled to the first common flow path (TBK) via the first flow path selection unit (VBK) and can be coupled to the second common flow path (TM) via the second flow path selection unit (VM).

The fourth supply flow path (SM) can be coupled to the second common flow path (TM) via the second flow path selection unit (VM).

According to such a configuration, color recording can be performed using the first recording liquid (BK) and the second recording liquid (M) of a color different from that of the first recording liquid (BK). In addition, since the liquid contained in the third liquid container (RW) can be supplied to both the first nozzle (13BK) and the second nozzle (13M), a degree of freedom in a usage aspect of the third liquid container is improved.

The treatment liquid supply flow path SCP is coupled to all of the four flow path selection units in the above embodiment, and alternatively may be coupled to only any one or a plurality of flow path selection units.

In the above configuration, the second supply flow path (SCP) can be coupled to the first common flow path (TBK) via the first flow path selection unit (VBK) and can be coupled to the second common flow path (TM) via the second flow path selection unit (VM).

According to such a configuration, since the liquid contained in the second liquid container (RCP) can be supplied to both the first nozzle (13BK) and the second nozzle (13M), a degree of freedom in a usage aspect of the second liquid container (RCP) is improved.

In the above-described embodiment, when the treatment liquid is ejected from the first nozzle (13BK), the third supply flow path (SW) is coupled to the second common flow path (TM) via the second flow path selection unit (VM). This is shown in the treatment mode shown in FIG. 6. Accordingly, the following operational effects can be obtained.

Even when the treatment liquid is ejected from the first nozzle (13BK), since the liquid is also ejected or suctioned from the second nozzle (13M) during maintenance or the like, the liquid is wasted, and the cost of the liquid increases. However, according to the above-described aspect, when the treatment liquid is ejected from the first nozzle (13BK), since the third supply flow path (SW) is coupled to the second common flow path (TM) via the second flow path selection unit (VM), the cost of the liquid can be reduced by containing the cleaning liquid in the third liquid container (RW). This is because the cleaning liquid is less expensive in most cases than the recording liquid and the treatment liquid.

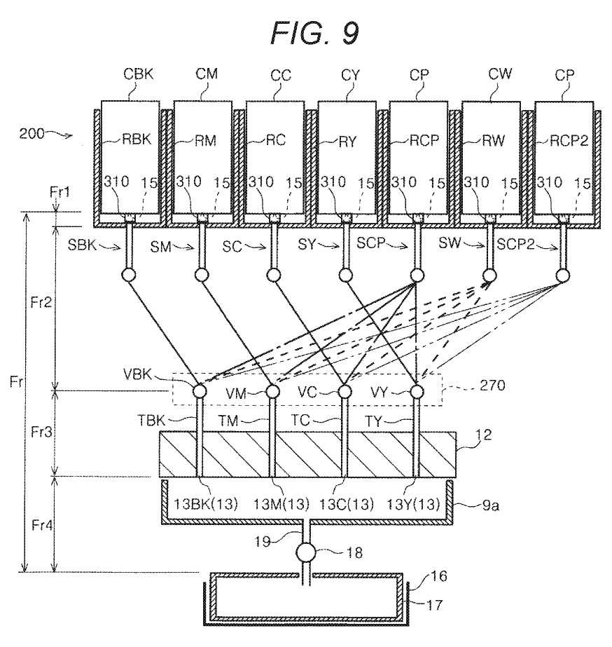

In the above configuration, a treatment liquid container may be further provided. A configuration shown in FIG. 9 is an example thereof. The configuration shown in FIG. 9 further includes a fifth liquid container (RCP2) that can contain the treatment liquid. Reference sign SCP2 denotes a fifth supply flow path through which the liquid is supplied from the fifth liquid container (RCP2). The fifth supply flow path SCP2 branches into four flow paths, and a section from a branch portion to each flow path selection unit is indicated by a two-dot chain line. The configuration shown in FIG. 9 has the following features.

The first supply flow path (SBK) can be coupled to the first common flow path (TBK) via the first flow path selection unit (VBK).

The second supply flow path (SCP) can be coupled to the first common flow path (TBK) via the first flow path selection unit (VBK).

The third supply flow path (SW) can be coupled to the first common flow path (TBK) via the first flow path selection unit (VBK) and can be coupled to the second common flow path (TM) via the second flow path selection unit (VM).

The fourth supply flow path (SM) can be coupled to the second common flow path (TM) via the second flow path selection unit (VM).

The fifth supply flow path (SCP2) can be coupled to the second common flow path (TM) via the second flow path selection unit (VM).

According to such a configuration, the treatment liquid can be stored in the fifth liquid container (RCP2) in addition to the second liquid container (RCP). Accordingly, different types of treatment liquids can be used. For example, the pre-treatment liquid cartridge CPa can be mounted at the second liquid container (RCP), and the post-treatment liquid cartridge CPb can be mounted at the fifth liquid container (RCP2). It should be noted that the same type of treatment liquid may be contained in the second liquid container (RCP) and the fifth liquid container (RCP2), or other types of cartridges may be mounted.

In the configuration in FIG. 9, when the treatment liquid is ejected from the first nozzle (13BK), the third supply flow path (SW) can still be coupled to the second common flow path TM via the second flow path selection unit (VM). This is shown in the treatment mode shown in FIG. 6. Accordingly, the cost of the liquid can be reduced as described above.

The embodiment described above can further adopt the following modification.

In each embodiment described above, the liquid ejection unit 12 is a line head and is fixedly provided. However, the liquid ejection unit 12 as described above may be an ink ejection head that is mounted at a carriage and ejects the liquid while moving in the medium width direction. In this case, the cartridge mounting portion 200 may be provided at the carriage or may be fixedly provided outside the carriage.

In the embodiment, the cartridge is used as the container for containing the liquid, but the container is not limited thereto. For example, a liquid-containing pack that contains the liquid may be used. Alternatively, each container (RBK, RM, RC, RY, RCP, RW) may be configured as a liquid tank, and the liquid tank may be of a type that allows the liquid to be refilled.

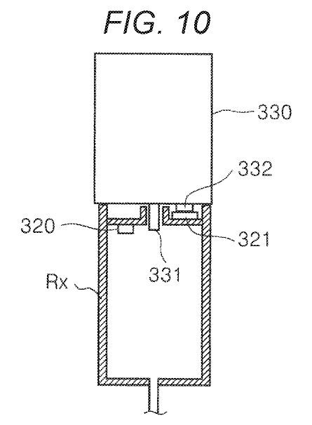

In the type in which the liquid tank is refilled with the liquid, the liquid can be refilled from a refill container containing the liquid. FIG. 10 is an example thereof, and reference numeral Rx denotes the liquid tank, reference numeral 330 denotes the refill container, and reference numeral 331 denotes an injection nozzle of the refill container 330. In such a configuration, a detection unit 320 that can detect an amount of the liquid contained in the liquid tank Rx may be provided. Further, in such a configuration, the refill container 330 may be provided with an information storage unit 332 that stores information on the liquid, and the liquid tank Rx may be provided with a contact 321 that can contact the information storage unit 332. With this configuration, the control unit 80 can acquire information such as the type of the liquid stored in the information storage unit 332.

When the recording is performed on the medium after the pre-treatment is performed on the medium by the pre-treatment mode, as an method for applying the pre-treatment liquid, the pre-treatment liquid may be applied to the entire surface of the medium, or the pre-treatment liquid may be applied only to a region where recording is performed. When the pre-treatment liquid is applied only to the region where recording is performed, the size of the region where the pre-treatment liquid is applied and the size of the region where recording is performed may match, or the pre-treatment liquid may be applied to a region slightly larger than the region where recording is performed. In the case of the treatment mode, the user may be allowed to set in advance whether the application to the entire surface or the application limited to the recording region is to be executed.

When the pre-treatment is performed on the medium by the pre-treatment mode, ejection accuracy may be lower than that in a case where recording is performed using the ink, and accordingly, when the pre-treatment is performed on the medium by the pre-treatment mode, it is also preferable to set a medium conveyance speed to be higher than that in a case where recording is performed using the ink.

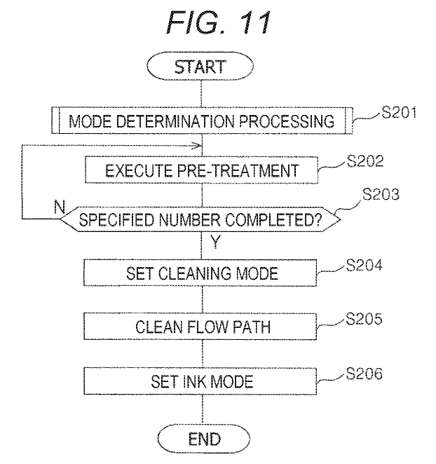

The control unit 80 can receive a reserved job as shown in FIG. 11. Hereinafter, an example in which the pre-treatment is performed on the medium will be described as an example of the reserved job.

FIG. 11 shows a flow of the reserved job, and upon receiving the reserved job, the control unit 80 performs mode determination processing (step S201). Such mode determination processing is the same as step S15 in FIG. 7, that is, the processing in FIG. 8.

Next, the control unit 80 performs the pre-treatment on the medium by the treatment mode or the treatment mode (high speed) in FIG. 6 (step S202). When the pre-treatment is performed on a specified number of media (Yes in step S203), the control unit 80 sets the cleaning mode (see FIG. 6) and performs the flow path cleaning (step S205). Thereafter, the ink mode (see FIG. 6) is set based on information in contents of the reserved job (step S206), and the processing is ended.

In this way, when the control unit 80 can receive the reservation for cleaning the flow path by the cleaning mode and switching to the recording mode after the job in the treatment mode is completed, usability is improved. For example, when ejection of the treatment liquid and ejection of the recording liquid are performed on a large amount of media, since the ejection of the treatment liquid, the cleaning of the flow path, and the switching to the ink mode are completed by executing the reservation, the ink can be quickly ejected.

As an example, if the reserved job is executed upon business closing in a store or an office, since the treatment liquid is ejected to a large amount of media until the business is started on a next day and switching to the ink mode is further completed, it is possible to immediately record on the media onto which the treatment liquid has been ejected when the business is started on the next day, and thus it is possible to improve business efficiency. In such a case, in step S202 of the reserved job, by applying the pre-treatment liquid to the entire surface of the medium, it is possible to more effectively obtain an effect of improving recording quality by the pre-treatment regardless of an image recorded with the ink.

### Control Related to Discharge of Waste Liquid to Waste Liquid Container

Next, control related to discharge of the waste liquid to the waste liquid container 17 will be described.

In the embodiment, the control unit 80 or the control method implemented by the control unit 80 does not discharge the treatment liquid to the waste liquid container 17 when the ink is contained in the waste liquid container 17, and does not discharge the ink to the waste liquid container 17 when the treatment liquid is contained in the waste liquid container 17. Accordingly, it is possible to prevent the ink and the treatment liquid from being mixed in the waste liquid container 17.

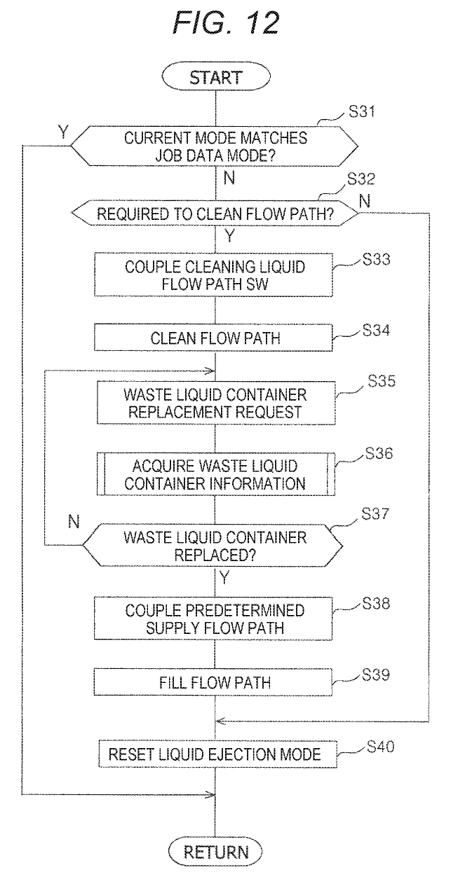

Such control by the control unit 80 will be described with reference to steps S35 to S37 in FIG. 12. Since steps S31 to S34 and S38 to S40 in FIG. 12 are the same as those in FIG. 8, redundant descriptions will be omitted.

After cleaning the flow path Fr (step S34), the control unit 80 displays, on the operation panel 86, a replacement request for the waste liquid container 17 (step S35).

At this time, the UI of the operation panel 86 may include a message such as "Please replace the waste liquid container with a new one." as an example.

That is, according to the flow in FIG. 12, the waste liquid container 17 before replacement contains the ink and the cleaning liquid, or contains the treatment liquid and the cleaning liquid. The cleaning of the flow path Fr is switching from the ink mode to the treatment mode or switching from the treatment mode to the ink mode, and thus the ink and the treatment liquid are mixed inside the waste liquid container 17 unless the waste liquid container 17 is replaced.

Accordingly, the control unit 80 prompts the user to replace the waste liquid container 17 after cleaning the flow path Fr (step S34).

After replacing the waste liquid container 17, the user presses, for example, the "replacement completion button" displayed on the UI of the operation panel 86. In response to this, the control unit 80 acquires the information from the waste liquid container IC 230 (step S36), and when the mounted waste liquid container 17 is new (Yes in step S37), the processing proceeds to step S38.

In this way, the control unit 80 prompts replacement of the waste liquid container 17 before switching from one of the recording mode and the treatment mode to the other. Accordingly, it is possible to more reliably prevent the ink and the treatment liquid from being mixed in the waste liquid container 17.

The control unit 80 switches to the cleaning mode before switching from one mode of the recording mode and the treatment mode to the other mode, and switches from the one mode to the other mode when the waste liquid container 17 is replaced after the cleaning of the flow path Fr is completed. Accordingly, it is possible to prevent mixing of the ink and the treatment liquid in the flow path Fr.

The control unit 80 can store a type of waste liquid discharged to the waste liquid container 17 mounted at the mounting portion 16 in the waste liquid container IC 230, which is an example of a storage medium, or the nonvolatile memory 83. Accordingly, it is possible to more reliably prevent the ink and the treatment liquid from being mixed in the waste liquid container 17.

In addition, since the type of the waste liquid contained in the waste liquid container 17 can be stored, the waste liquid container 17 can be used by being attached again after being detached from the mounting portion 16 while preventing the ink and the treatment liquid from being mixed.

In the above-described example, the replacement of the mounted waste liquid container 17 is prompted after the end of the cleaning processing (steps S35 to S37), and alternatively, the replacement of the waste liquid container 17 may be prompted before the cleaning processing. That is, steps S35 to S37 may be executed before step S34.

However, when the waste liquid container 17 is not of a type that is repeatedly attached and detached for use and the waste liquid container 17 before replacement is not full, it is preferable to discharge the waste liquid to the waste liquid container 17 before replacement such that a capacity of the waste liquid container 17 can be effectively used.

The information on the waste liquid container 17 may be acquired each time the waste liquid is discharged, specifically, each time the pump 18 is driven, and it may be determined whether the waste liquid to be discharged is compatible with the currently mounted waste liquid container 17 each time.

In the above-described example, the information on the waste liquid container 17 is acquired from the waste liquid container IC 230 (step S36), and it is determined whether the waste liquid container 17 has been replaced based on a result thereof (step S37), and instead of step S36, the determination may be performed based on opening and closing of an opening and closing cover (not shown) for attaching and detaching the waste liquid container 17. That is, when the opening and closing cover is opened and closed, it may be determined that the waste liquid container 17 has been replaced. In this case, the waste liquid container IC 230 may not be necessarily provided. Alternatively, instead of step S36, a message "Has the waste liquid container been replaced?" may be displayed on the UI of the operation panel 86, and when the user presses "Yes" in response to this, it may be determined that the waste liquid container 17 has been replaced. In this case, the waste liquid container IC 230 may also not be necessarily provided.

In addition, in the above-described example, the control unit 80 performs control to avoid mixing of the ink and the treatment liquid, and alternatively, control may be performed to mix the ink and the treatment liquid via the cleaning liquid as long as a reaction such as hardening can be avoided by mixing the ink and the treatment liquid via the cleaning liquid. In addition, if a reaction such as hardening occurs due to mixing of different types of treatment liquids, the control unit 80 may perform control to avoid mixing of different types of treatment liquids.

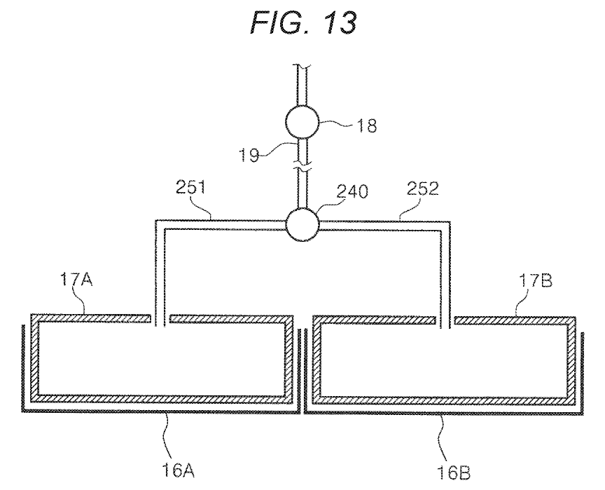

Next, an example using a plurality of waste liquid containers will be described with reference to FIG. 13. In the configuration shown in FIG. 13, a first mounting portion 16A includes a first waste liquid container 17A, and a second mounting portion 16B includes a second waste liquid container 17B. Reference sign 240 denotes a switching unit that switches a flow destination of the waste liquid, the switching unit 240 and the first waste liquid container 17A are coupled by a tube 251, and the switching unit 240 and the second waste liquid container 17B are coupled by a tube 252. The tube 251 forms a first waste liquid flow path through which the waste liquid flows to the first waste liquid container 17A, and the tube 252 forms a second waste liquid flow path through which the waste liquid flows to the second waste liquid container 17B.

The tube 19 forms a common waste liquid flow path through which the waste liquid flows from the cap 9a to the first waste liquid flow path and the second waste liquid flow path.

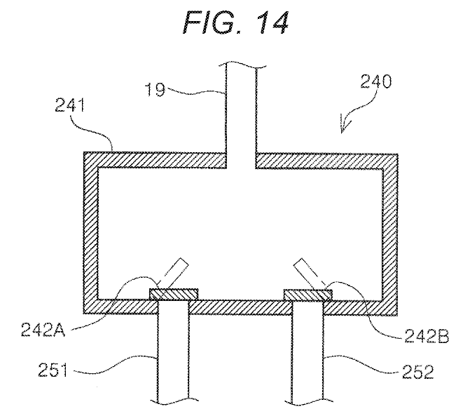

As the switching unit 240, a known valve can be adopted, and as an example, as shown in FIG. 14, valves 242A and 242B are provided in a case 241. These valves can be configured with, for example, solenoid valves. For each valve, a solid line indicates a closed state and a two-dot chain line indicates an open state.

When the valve 242A is opened and the valve 242B is closed, the flow destination of the waste liquid becomes the first waste liquid container 17A. When the valve 242A is closed and the valve 242B is opened, the flow destination of the waste liquid becomes the second waste liquid container 17B.

The switching unit 240 can be controlled by the control unit 80. The control unit 80 does not discharge the treatment liquid to the first waste liquid container 17A when the ink is contained in the first waste liquid container 17A, and does not discharge the ink to the first waste liquid container 17A when the treatment liquid is contained in the first waste liquid container 17A. Similarly, the control unit 80 does not discharge the treatment liquid to the second waste liquid container 17B when the ink is contained in the second waste liquid container 17B, and does not discharge the ink to the second waste liquid container 17B when the treatment liquid is contained in the second waste liquid container 17B.

Accordingly, it is possible to prevent the ink and the treatment liquid from being mixed in both the first waste liquid container 17A and the second waste liquid container 17B.

When the discharge destination is switched, it is preferable to discharge the liquid inside the switching unit 240, empty the inside of the switching unit 240, and then introduce the liquid to be discharged next into the switching unit 240. Accordingly, it is possible to prevent different liquids from being mixed inside the switching unit 240.

Next, in such a configuration, the control unit 80 or the control method implemented by the control unit 80 may discharge the ink to the first waste liquid container 17A and discharge the treatment liquid to the second waste liquid container 17B. By discharging different liquids in the first waste liquid container 17A and the second waste liquid container 17B in this way, it is possible to discharge the ink and the treatment liquid without requiring the user to perform a special replacement operation. The control unit 80 may discharge the treatment liquid to the first waste liquid container 17A and discharge the ink to the second waste liquid container 17B.

In this case, the control unit 80 may discharge the ink to the first waste liquid container 17A when the ink is contained in the first waste liquid container 17A or the waste liquid is not contained in the first waste liquid container 17A, and may discharge the treatment liquid to the second waste liquid container 17B when the treatment liquid is contained in the second waste liquid container 17B or the waste liquid is not contained in the second waste liquid container 17B. In this way, use of each waste liquid container can be set.

Next, the liquid ejection unit 12 can eject the first treatment liquid and the second treatment liquid as the treatment liquid. The first treatment liquid and the second treatment liquid are liquids having reactivity such as hardening when mixed, and for example, one is the pre-treatment liquid and the other is the post-treatment liquid.

When the ink is contained in the first waste liquid container 17A and the first treatment liquid is contained in the second waste liquid container 17B, the control unit 80 may prompt replacement of the first waste liquid container 17A or the second waste liquid container 17B without discharging the second treatment liquid to any of the first waste liquid container 17A and the second waste liquid container 17B.

In addition, when the first treatment liquid is contained in the first waste liquid container 17A and the second treatment liquid is contained in the second waste liquid container 17B, the control unit 80 may prompt the replacement of the first waste liquid container 17A or the second waste liquid container 17B without discharging the ink to any of the first waste liquid container 17A and the second waste liquid container 17B.

Accordingly, it is possible to prevent a plurality of types of waste liquid from being mixed in the first waste liquid container 17A or the second waste liquid container 17B.

Next, in a configuration in which a plurality of waste liquid containers can be mounted, the control unit 80 may switch the switching unit 240 before switching from one of the recording mode and the treatment mode to the other. In this way, since the control unit 80 switches the switching unit when the mode is switched, it is possible to prevent a plurality of types of the waste liquid from being mixed in the first waste liquid container 17A or the second waste liquid container 17B.

In a configuration in which a plurality of waste liquid containers are provided, the control unit 80 may grasp an amount of the waste liquid contained in the first waste liquid container 17A and an amount of the waste liquid contained in the second waste liquid container 17B, and discharge the cleaning liquid to the waste liquid container where the amount of the contained waste liquid is small between the first waste liquid container 17A and the second waste liquid container 17B. Accordingly, a replacement frequency of the waste liquid container can be reduced.

The control unit 80 may discharge the cleaning liquid to the waste liquid container suitable for the current liquid ejection mode, and in this case, the number of times of switching of the switching unit 240 can be reduced.

In addition, when an absorbent material that absorbs the waste liquid is provided inside the waste liquid container, the cleaning liquid may be preferentially discharged to a side where the waste liquid easily clogs in the absorbent material. In addition, the cleaning liquid may be discharged to a side where the waste liquid that is prone to evaporation is contained.

In the configuration in which a plurality of waste liquid containers can be mounted, the control unit 80 may discharge the waste liquid of the same type to the first waste liquid container 17A and the second waste liquid container 17B. Accordingly, it is possible to reduce the replacement frequency of the waste liquid container when the waste liquid of the same type is discharged. In this case, one of the first waste liquid container 17A and the second waste liquid container 17B may be used first, and when the container becomes full, the other may be used, or the waste liquid may be uniformly discharged to both of the containers.

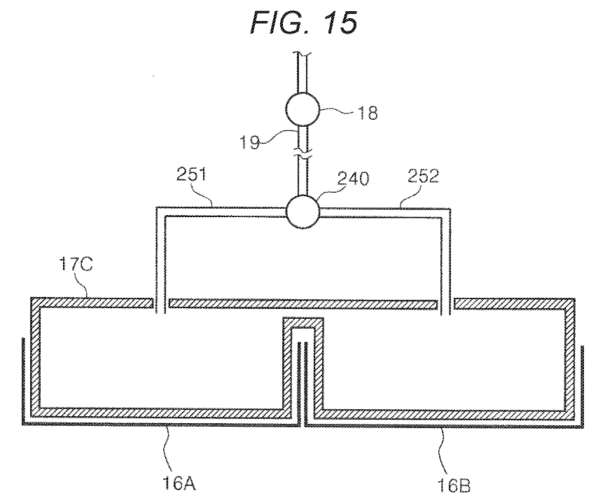

As shown in FIG. 15, a large-capacity waste liquid container 17C that can be mounted using spaces of both the first mounting portion 16A and the second mounting portion 16B may be mountable at the first mounting portion 16A and the second mounting portion. In this case, the control unit 80 or the control method implemented by the control unit 80 discharges the waste liquid of the same type to the large-capacity waste liquid container 17C. According to such a configuration, the replacement frequency of the waste liquid container can be reduced. A space inside the large-capacity waste liquid container 17C may be partitioned by a wall.

The present disclosure is not limited to the embodiment and the modification described above and various modifications can be made within the scope of the disclosure set forth in the appended claims, and it should be noted that these modifications also fall within the scope of the present disclosure.

What is claimed is:

1. A liquid ejection apparatus comprising:
a liquid ejection unit including a plurality of nozzles that eject a liquid onto a medium, the liquid being supplied from a plurality of liquid containers that contain the liquid;
a flow path configured to allow the liquid to flow from the liquid containers to the liquid ejection unit; and
a control unit configured to control the apparatus, wherein
the plurality of liquid containers include
a first liquid container that contains a recording liquid as the liquid for recording on the medium,
a second liquid container configured to contain a treatment liquid as the liquid for performing a treatment on the medium, and
a third liquid container configured to contain a cleaning liquid as the liquid for cleaning the flow path,
the flow path includes
a plurality of supply flow paths that allow the liquid to be supplied from the liquid containers,
a common flow path that is coupled to at least one of the plurality of supply flow paths and allows the liquid to flow to the liquid ejection unit, and
a switching unit that switches the supply flow path coupled to the common flow path, and
the plurality of supply flow paths include
a first supply flow path that supplies the liquid from the first liquid container,
a second supply flow path that supplies the liquid from the second liquid container, and
a third supply flow path that supplies the liquid from the third liquid container.

2. The liquid ejection apparatus according to claim 1, wherein
when the treatment liquid is contained in the second liquid container and the supply flow path coupled to the common flow path is switched from one of the first supply flow path and the second supply flow path to the other, the control unit couples the third supply flow path to the common flow path, cleans the common flow path with the cleaning liquid, and then switches the supply flow path coupled to the common flow path from the one of the first supply flow path and the second supply flow path to the other.

3. The liquid ejection apparatus according to claim 1, wherein
the control unit switches the supply flow path coupled to the common flow path after discharging the liquid in the common flow path.

4. The liquid ejection apparatus according to claim 1, wherein
the switching unit includes
a first switching valve that switches connection and disconnection between the common flow path and the first supply flow path,
a second switching valve that switches connection and disconnection between the common flow path and the second supply flow path, and
a third switching valve that switches connection and disconnection between the common flow path and the third supply flow path.

5. The liquid ejection apparatus according to claim 1, wherein
a flow path length of the common flow path is shorter than a flow path length of each of the first supply flow path, the second supply flow path, and the third supply flow path.

6. The liquid ejection apparatus according to claim 1, wherein
when the recording liquid is contained in the first liquid container and the second liquid container, the control unit couples the first supply flow path and the second supply flow path to the common flow path.

7. The liquid ejection apparatus according to claim 1, wherein
the control unit is capable of switching among
a recording mode in which the first supply flow path is coupled to the common flow path and the recording can be performed on the medium with the recording liquid,
a treatment mode in which the second supply flow path is coupled to the common flow path and the treatment can be performed on the medium with the treatment liquid, and
a cleaning mode in which the third supply flow path is coupled to the common flow path and the flow path can be cleaned with the cleaning liquid, and
the control unit is further configured to receive a reservation for cleaning the flow path by the cleaning mode and switching to the recording mode after a job in the treatment mode is completed.

8. The liquid ejection apparatus according to claim 1, wherein
the control unit is capable of switching among
a recording mode in which the first supply flow path is coupled to the common flow path and the recording can be performed on the medium with the recording liquid,
a treatment mode in which the second supply flow path is coupled to the common flow path and the treatment can be performed on the medium with the treatment liquid, and
a cleaning mode in which the third supply flow path is coupled to the common flow path and the flow path can be cleaned with the cleaning liquid, and
the control unit further detects, by receiving a job, switching from one mode of the recording mode and the treatment mode to the other mode, and switches the switching unit.

9. The liquid ejection apparatus according to claim 1, wherein
the control unit is capable of switching among
a recording mode in which the first supply flow path is coupled to the common flow path and the recording can be performed on the medium with the recording liquid,
a treatment mode in which the second supply flow path is coupled to the common flow path and the treatment can be performed on the medium with the treatment liquid, and
a cleaning mode in which the third supply flow path is coupled to the common flow path and the flow path can be cleaned with the cleaning liquid, and
the control unit further detects, based on an input from an input unit, mode switching, and switches the switching unit.

10. The liquid ejection apparatus according to claim 1, wherein
the recording liquid serves as a first recording liquid, the plurality of liquid containers further include a fourth liquid container that contains a second recording liquid of a color different from a color of the first recording liquid,
the plurality of supply flow paths further include a fourth supply flow path that supplies the liquid from the fourth liquid container,
the liquid ejection unit includes a first nozzle and a second nozzle that are nozzles for ejecting the liquid,
the common flow path is a first common flow path, and a second common flow path that is coupled to at least one of the plurality of supply flow paths and allows the liquid to flow to the liquid ejection unit is further provided,
the first common flow path allows the liquid to flow to the first nozzle,
the second common flow path allows the liquid to flow to the second nozzle,
the switching unit includes
a first flow path selection unit provided for the first common flow path, and
a second flow path selection unit provided for the second common flow path,
the first supply flow path is couplable to the first common flow path via the first flow path selection unit,
the third supply flow path is couplable to the first common flow path via the first flow path selection unit and couplable to the second common flow path via the second flow path selection unit, and
the fourth supply flow path is couplable to the second common flow path via the second flow path selection unit.

11. The liquid ejection apparatus according to claim 10, wherein
the second supply flow path is couplable to the first common flow path via the first flow path selection unit and couplable to the second common flow path via the second flow path selection unit.

12. The liquid ejection apparatus according to claim 10, wherein
when the treatment liquid is ejected from the first nozzle, the third supply flow path is coupled to the second common flow path via the second flow path selection unit.

13. The liquid ejection apparatus according to claim 1, wherein
the plurality of liquid containers further include
a fourth liquid container that contains, with the recording liquid being a first recording liquid, a second recording liquid of a color different from a color of the first recording liquid, and
a fifth liquid container configured to contain the treatment liquid,
the plurality of supply flow paths further include
a fourth supply flow path that supplies the liquid from the fourth liquid container, and
a fifth supply flow path that supplies the liquid from the fifth liquid container,
the liquid ejection unit includes a first nozzle and a second nozzle that are nozzles for ejecting the liquid,
the common flow path is a first common flow path, and a second common flow path that is coupled to at least one of the plurality of supply flow paths and allows the liquid to flow to the liquid ejection unit is further provided,
the first common flow path allows the liquid to flow to the first nozzle,
the second common flow path allows the liquid to flow to the second nozzle,
the switching unit includes
a first flow path selection unit provided for the first common flow path, and
a second flow path selection unit provided for the second common flow path,
the first supply flow path is couplable to the first common flow path via the first flow path selection unit,
the second supply flow path is couplable to the first common flow path via the first flow path selection unit,
the third supply flow path is couplable to the first common flow path via the first flow path selection unit and couplable to the second common flow path via the second flow path selection unit,
the fourth supply flow path is couplable to the second common flow path via the second flow path selection unit, and
the fifth supply flow path is couplable to the second common flow path via the second flow path selection unit.

14. The liquid ejection apparatus according to claim 13, wherein
when the treatment liquid is ejected from the first nozzle, the third supply flow path is coupled to the second common flow path via the second flow path selection unit.

15. The liquid ejection apparatus according to claim 1, wherein
a liquid holder that holds the liquid is attachable to and detachable from the liquid container.

16. The liquid ejection apparatus according to claim 1, wherein
the liquid container is refillable with the liquid from a refill container containing the liquid.

17. The liquid ejection apparatus according to claim 16, wherein
the refill container is provided with an information storage unit that stores information on the liquid, and
the liquid container includes
a contact couplable to a terminal for accessing the information storage unit, and
a detection unit that detects an amount of the liquid contained in the liquid container.
